(19) United States
(12) Patent Application Publication
(10) Pub. No.: US 2022/0358566 A1
(43) Pub. Date: Nov. 10, 2022

(54) EASY2SHOW

(71) Applicant: Jill Ihrke, Sheffield, IA (US)

(72) Inventor: Jill Ihrke, Sheffield, IA (US)

(21) Appl. No.: 17/737,443

(22) Filed: May 5, 2022

Related U.S. Application Data
(60) Provisional application No. 63/186,350, filed on May 10, 2021.

(51) Int. Cl. G06Q 30/06

(52) U.S. Cl. CPC G06Q 30/0637; G06Q 30/0283

(57) ABSTRACT

In one or more arrangements, a system for management of events is presented that includes a back-end system and a set of front-end systems communicatively connected to the back-end system. The front-end systems are configured to provide respective graphical user interfaces for an event hosts, exhibitors, and clubs to input and access data related to the event. Responsive to the input from the front-end systems, the back-end system is configured to automatically perform various operations to facilitate management and execution of the event. In one or more arrangements, the system is configured to perform operations to facilitate sanctioning of events by clubs, marketing of events, registration of exhibitors, payments related to the event, input of competition scoring, and/or reporting of finalized results, among other operations.

### CROSS REFERENCE TO RELATED APPLICATION

This application claims the benefit of U.S. Provisional Application No. 63/186,350 titled “EASY2SHOW” and filed on May 10, 2021, the entire contents of which is hereby fully incorporated by reference herein.

### FIELD OF THE DISCLOSURE

The present disclosure generally relates to computing architectures, systems, and methods for setup and management of events.

### OVERVIEW

Large events such as competitions, tradeshows, seminars, fairs, and/or other large events, can be difficult to arrange and manage due to the large number of persons and/or groups involved. Some systems exist to assist with some various tasks associated with hosting of events. For example, U.S. Pat. No. 11,087,287 describes a system and method for generating event invitations to specified recipients. As another example, U.S. Pat. No. 11,270,396 describes a system for automated event space management with conflict prevention.

However, current systems do not address the heavy workload associated with operations for hosting events including exhibitions (e.g., competitions). Current systems also do not address the heavy workload associated with operations for hosting events sanctioned by third parties. For example, some events (such as animal exhibitions) may be sanctioned by one or more local, regional and/or national clubs. Arrangements for such events are typically initiated by an event host (e.g., a host club) approximately a year in advance to reserve facilities at which the event will take place. Approximately 1-2 months before the event, the event host begins marketing efforts to garner interest among potential exhibitors (e.g. competitors, contestants, vendors, participants, and/or other attendees), typically with a deadline for entry approximately 1 week before and up to the day of the show. Currently, the event host manually enters entries into a database used for management of the event. Due to the large size of many events, such data entry can be an exceedingly challenging task. For example, the National Rabbit show the deadline is 2-3 weeks before due to all the manual data entry needed for 25,000+/− entries in time for the event.

Sanctioning of the event by third party clubs can also be challenging for an event host. Months to a year before the event, the event host contacts clubs who the event host desires to sanction the event. However, for many events related to niche hobbies and/or competitions, many clubs do not have automated systems for application, payment, and approval of sanctioning for events. Rather, sanctioning of events is typically manually performed via email and/or mail with payment in the form of online or by mail. Sanctioning of events in this manner can be overly burdensome on event host due to the large number of clubs that may sanction an individual event. For example, an event for exhibition of rabbits may be sanctioned by as many as 50 individual clubs (with an average of 20-30 clubs). After submitting applications, the event host must typically wait for a response from the clubs contacted indicating whether of not sanctioning of the event was approved. The response is in the form of an email or mail with a “sanction” number (in most cases) acknowledging that the club accepts the event host's application for sanction. The event host must manually monitor sanction applications and may need to follow up with the club again if the application doesn't get a response, which can be overly burdensome.

Furthermore, different clubs may have different requirements for sanctioning (e.g., rules, non-member fees/payment, participant qualifications, judging criteria, and/or reporting requirements). For example, competition results reports must typically be customized for each club to display the sanction number assigned by the club. Additionally or alternatively, a club may require evaluation of additional criteria and reporting of additional information, for example, to facilitate management of special awards, sweepstakes, certifications (e.g., legs), titles, member ranking/standing, and/or other information or data metrics that may be tracked by the club. Due in part to the need to obtain sanctions from a large number of clubs hosting of club sanctioned events generally requires a host to manually manage club sanction requirements, customization of scoring sheets, recording of scores, and reporting of competition results.

Determining and reporting of results after scoring also requires several manual processes that can also be burdensome on the event host. In many competitions, entries are scored by hand on paper score cards. Paper score cards permit judges to add additional special comments or encouragement regarding an entry, which are considered to be essential for many youth events. However, manual entry of data from such paper score cards can be very time consuming. Surveys indicate that event hosts may spend approximately 20-40 hours (depending on the show size) to data enter the results, send reports, and finalize the show. The event host must also generate customized results reports for each club that sanctioned the event. Typically clubs require such customized reports to be provided within a certain period following the event (e.g., 30 days).

Reporting of results can also pose a significant challenge to clubs as well as exhibitors. Currently, an event host provides final competition results and awards awarded by the event directly to the exhibitors and provides customized reports to each club sanctioning the event. Customized reports may be used internally by the club to facilitate awarding of special awards and/or certificates by the club and/or facilitate tracking of certificates, titles, member ranking/standing, and/or other information or statistics that may be tracked by the club. Accordingly, for some clubs, members participating in an event may need to access multiple locations (e.g., websites) to know all results and awards received. Evaluating of reports to determine club awards and/or to track information may also be overly burdensome for many clubs.

For at least the above reasons there is a long felt need for an improved system for management of events sanctioned by third parties.

Thus, it is a primary object of the disclosure to provide a system for management of events that improves upon the state of the art.

Another object of the disclosure is to provide a system for management of events that is less time consuming.

Yet another object of the disclosure is to provide a system for management of events that is less error prone.

Another object of the disclosure is to provide a system for management of events that provides additional functionality.

Yet another object of the disclosure is to provide a system for management of events that is easy to use.

Another object of the disclosure is to provide a system for management of events that reduces manual entry of data.

Yet another object of the disclosure is to provide a system for management of events that automates application for sanctioning of the events by clubs.

Another object of the disclosure is to provide a system for management of events that manages requirements imposed by clubs sanctioning of the events.

Yet another object of the disclosure is to provide a system for management of events that automates reporting of results of the events.

Another object of the disclosure is to provide a system for management of events that facilitate reporting of special awards, certificate, titles, or other accolade award by clubs that sanction the events.

These and other objects, features, or advantages of the present disclosure will become apparent from the specification, claims and drawings.

### SUMMARY

In one or more arrangements, a system for management of events is presented that includes a back-end system and a set of front-end systems communicatively connected to the back-end system. The back-end system includes having a database and a data processing system. In one or more arrangements, a first front-end systems is configured to provide a graphical user interface for an event host to create and configure an event and select a set of clubs the event host would like to sanction the event. In response to the set of clubs being selected via the graphical user interface provided by the first front-end system, the data processing system submits applications for purchase of sanctions from the set of clubs for the event. The data processing system is configured to track approval status of the applications for purchase of sanctions in the database. The data processing system is configured to store respective sets of club requirements for approved sanctions of the set of sanction sanctions in the database. A second front-end system is configured to provide a graphical user interface for exhibitors to register for the event. The data processing system is configured to maintain registration information for the exhibitors for the event in the database. Upon determining finalized results of the event for the exhibitors, the data processing system is configured to generate a customized report of the finalized results of the event for each of the approved sanctions according to the respective set of club requirements for the approved sanction. In one or more arrangements, the data processing system is configured to communicate the customized report to one of the set of clubs from whish the sanction was purchased.

In one or more arrangements, the back-end system is configured to receive scoring data for the exhibitors from a set of judges and store the scoring data the database. The back-end system is configured to automatically determine the finalized results from the received scoring data. In one or more arrangements, the respective set of club requirements for at least one of the approved sanctions specifies data to be included in the customized report. In one or more arrangements, the respective set of club requirements for at least one of the approved sanctions specifies a sanctions number to be included in the customized report.

In one or more arrangements, the respective set of club requirements for at least one of the approved sanctions requires payment of a fee per entry in the event to the club from which the approved sanction was purchased. In one or more arrangements, after closing of registration, the back-end system is configured to automatically calculate the total payment for the fee per entry from data stored in the database. In one or more arrangements, the back-end system is configured to automatically submit the calculated total payment to the club from which the approved sanction was purchased.

In one or more arrangements, the respective set of club requirements for at least one of the approved sanctions requires the event to include a club-specific award. In one or more arrangements, the requirements specify a set of eligibility requirements for exhibitors to be allowed to compete for the club-specific award. In one or more arrangements, the back-end system is configured to prevent exhibitors from registering to compete for the club-specific award unless the exhibitors satisfy the set of eligibility requirements.

In one or more arrangements, a third front-end system configured to provide a graphical user interface for the set of clubs to register with the back-end system and process the applications for sanctions that are submitted by the data process system of the back-end system. In one or more arrangements, the third front-end system configured to provide each of the set of clubs, from which approved sanctions were purchased, access the respective the custom report of the finalized results generated for the club by the data processing server.

In one or more arrangements, the data processing server is configured to track and maintain results and standings for members of the at least one club. In one or more arrangements, the third front-end system configured to provide the members of the at least one club access to the results and standings for members of the at least one club. In one or more arrangements, the second front-end system is configured to permit the exhibitors to initiate electronic payment for the registration using the back-end system.

In one or more arrangements, the data processing system is configured to generate a respective check-in/check-out sheet for each of the exhibitors indicating information for animals the exhibitor registered to bring to the event. In one or more arrangements, the first front-end system is configured to permit a first one of the exhibitors to initiate a transaction for sale of at least one animal they registered to bring to the event to a second one of the exhibitors for a specified amount. In one or more arrangements, in response to the transaction being initiated, the data processing system is configured to electronically transfer payment for the specified amount from the second one of the exhibitors to the first one of the exhibitors and update the respective check-in/check-out sheets for the first one of the exhibitors and the second one of the exhibitors to indicate the sale of the at least one animal. In one or more arrangements, in initiation of the transaction, the first one of the exhibitors uses the second front-end system to input or select an identifier for the at least one animal and input or select an identifier for the second one of the exhibitors. In one or more arrangements, the second front-end system is configured to provide each of the exhibitors access to the respective check-in/check-out sheet generated for the exhibitor.

### BRIEF DESCRIPTION OF THE FIGURES

FIG. 1 shows a system for managing an event, in accordance with one or more embodiments.

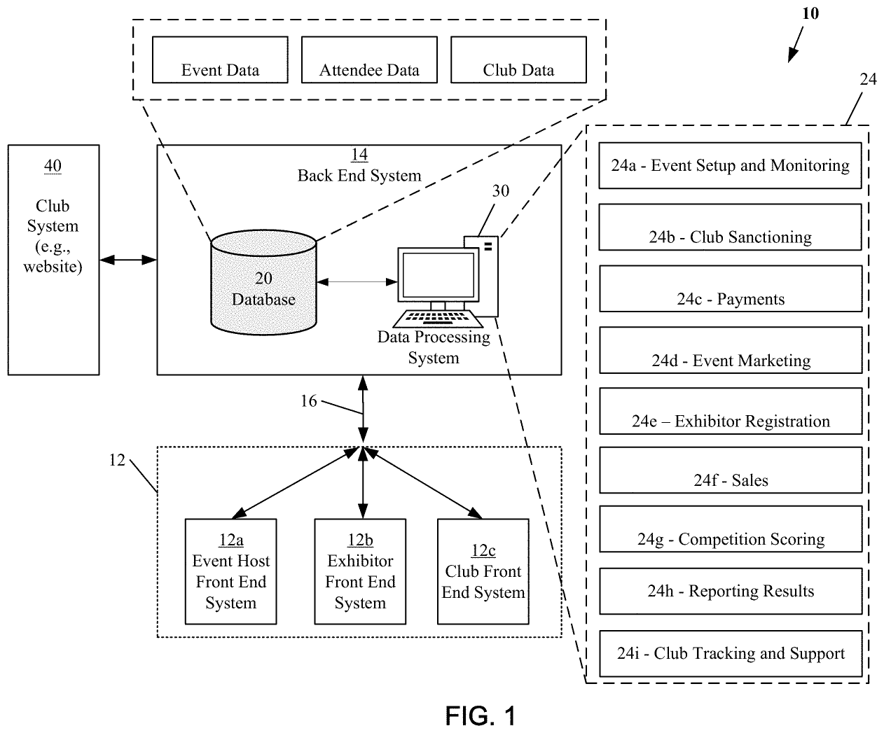

FIG. 2 shows an example data processing system, in accordance with one or more embodiments.

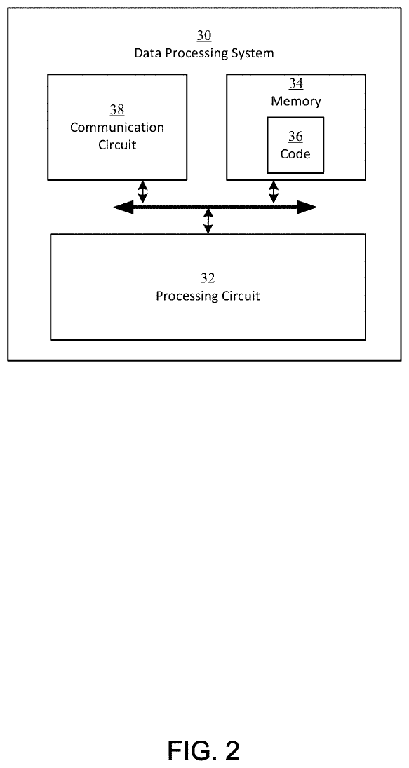

FIG. 3 shows an example process table showing operational flow and tasks performed by an event host using event host front-end system for an event, in accordance with one or more embodiments; the process table showing operational interactions with the other front-end systems.

FIG. 4 shows an example process table showing operational flow and tasks performed by an exhibitor using exhibitor front-end system for an event, in accordance with one or more embodiments; the process table showing operational interactions with the other front-end systems.

FIG. 5 shows an example process table showing operational flow and tasks performed by a club using club front-end system for an event, in accordance with one or more embodiments; the process table showing operational interactions with the other front-end systems.

FIG. 6 shows a screen shot view of an example graphical user interface for a front-end system, in accordance with one or more embodiments; the view showing an example interface screen for login to front-end systems.

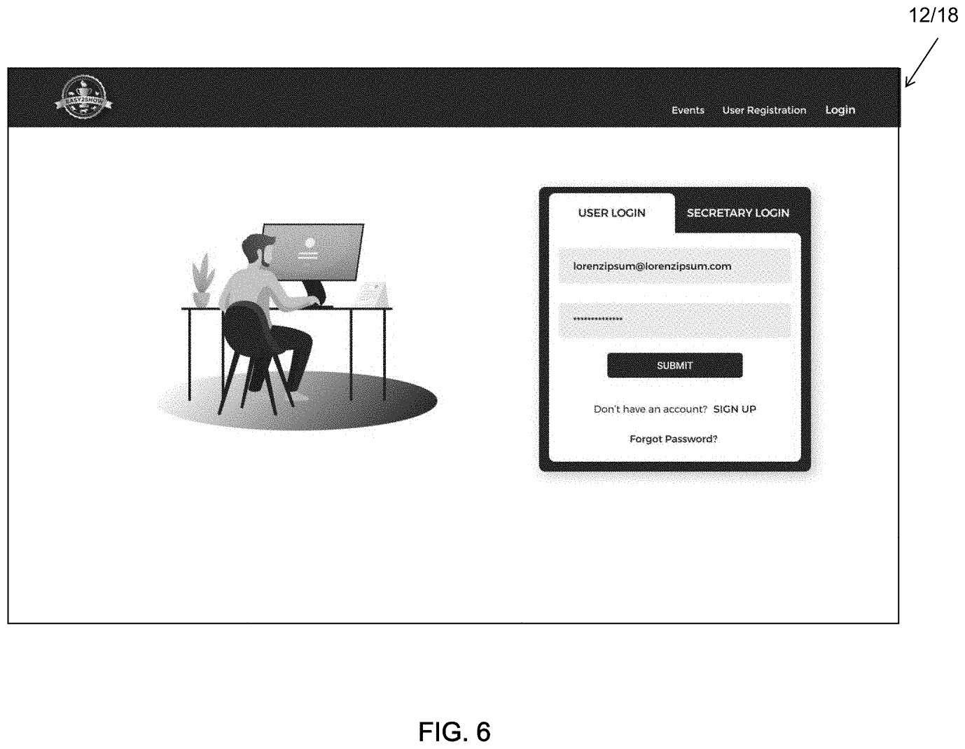

FIG. 7 shows a screen shot view of an example graphical user interface for an event host front-end system, in accordance with one or more embodiments; the view showing an example interface screen for setup and configuration of an event by an event host.

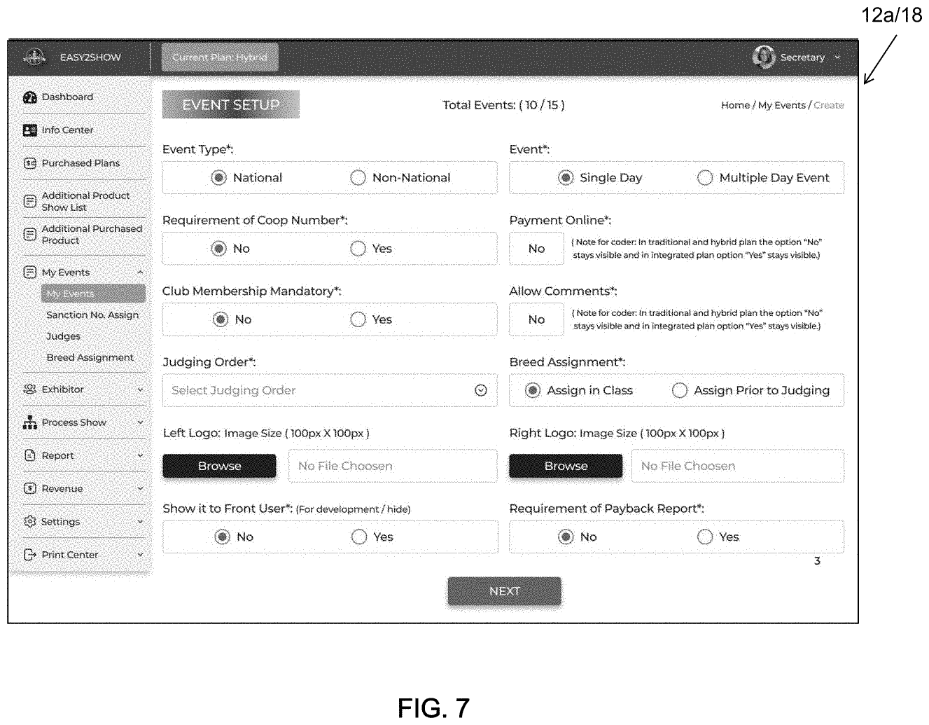

FIG. 8 shows a screen shot view of an example graphical user interface for an event host front-end system, in accordance with one or more embodiments; the view showing an example interface screen for access to and management of event that have been setup by an event host.

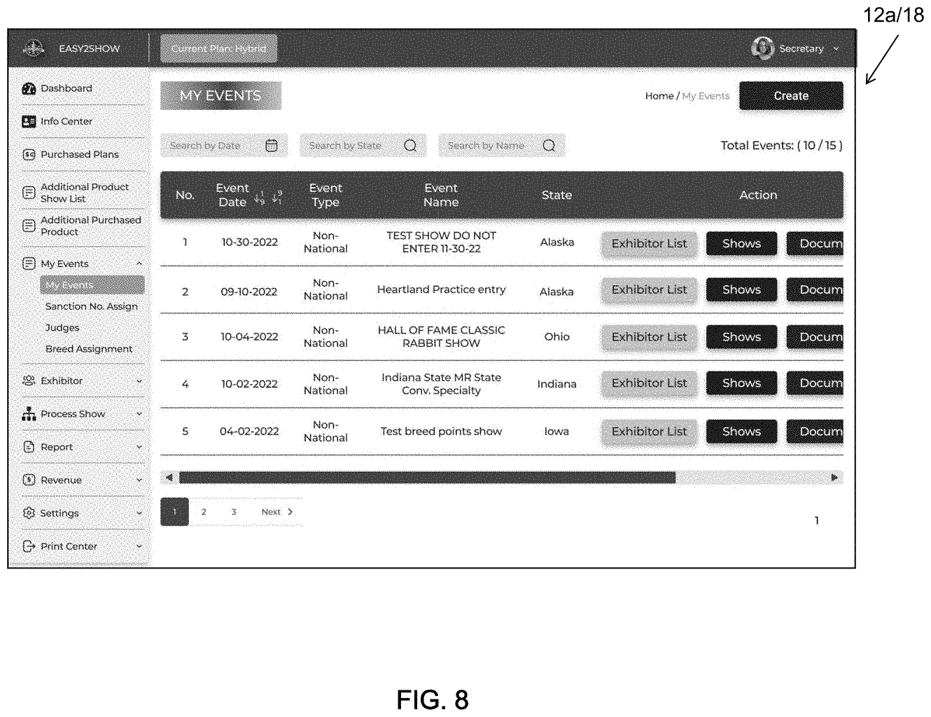

FIG. 9 shows a screen shot view of an example graphical user interface for an event host front-end system, in accordance with one or more embodiments; the view showing an example interface screen for viewing and managing events by a user of an event host; the interface screen configured to permit user to view and edit information and/or statistics for the event, exhibitor, entries, and/or classes/competitions, and/or process and finalize event information/results; the example interface screen showing a list of breeds/categories for an event, entry/exhibitor count for each breed/category, status of judging for each breed/category, the example interface screen having buttons to permit the user to perform various actions to manage the event (e.g., finalizing results and generating results reports for the event).

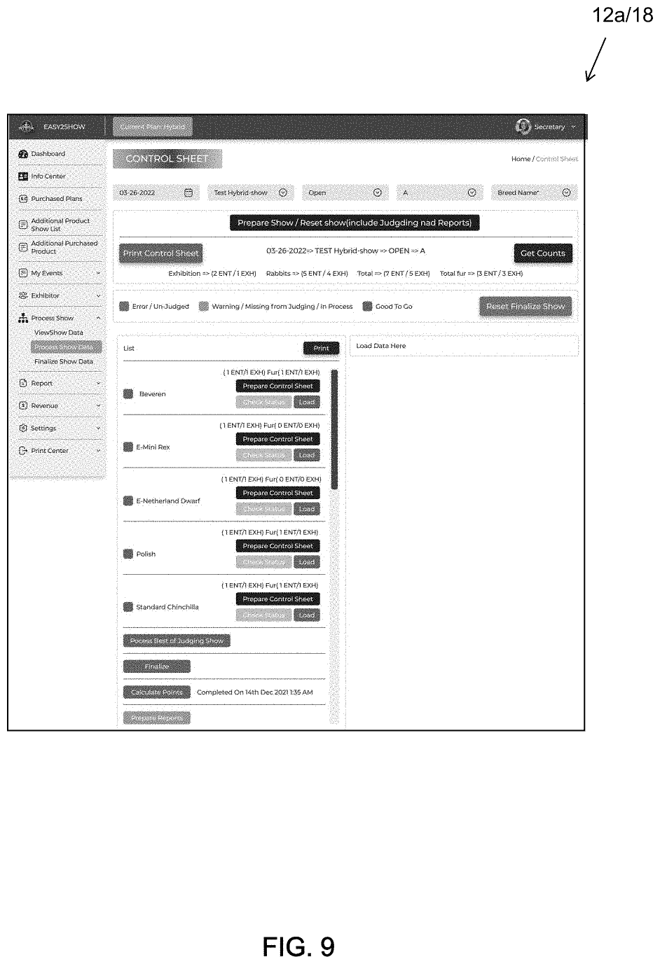

FIG. 10 shows a screen shot view of the example graphical user interface for an event host front-end system shown in FIG. 9, in accordance with one or more embodiments; the view showing detailed information panel for a particular breed/category that was selected by the user; the information panel showing judging status and other information classes/competitions for the selected breed/category and having buttons for users to select specific classes/competitions to view and/or perform various operations.

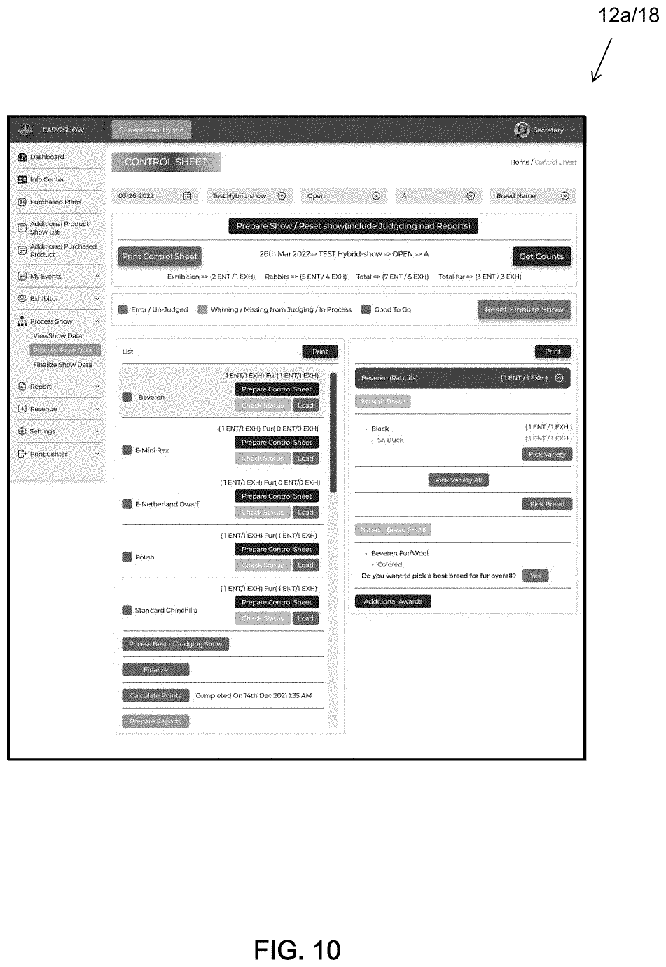

FIG. 11 shows a screen shot view of an example graphical user interface for an exhibitor host front-end system, in accordance with one or more embodiments; the view showing an example interface screen for exhibitor users to search for and view information on upcoming events.

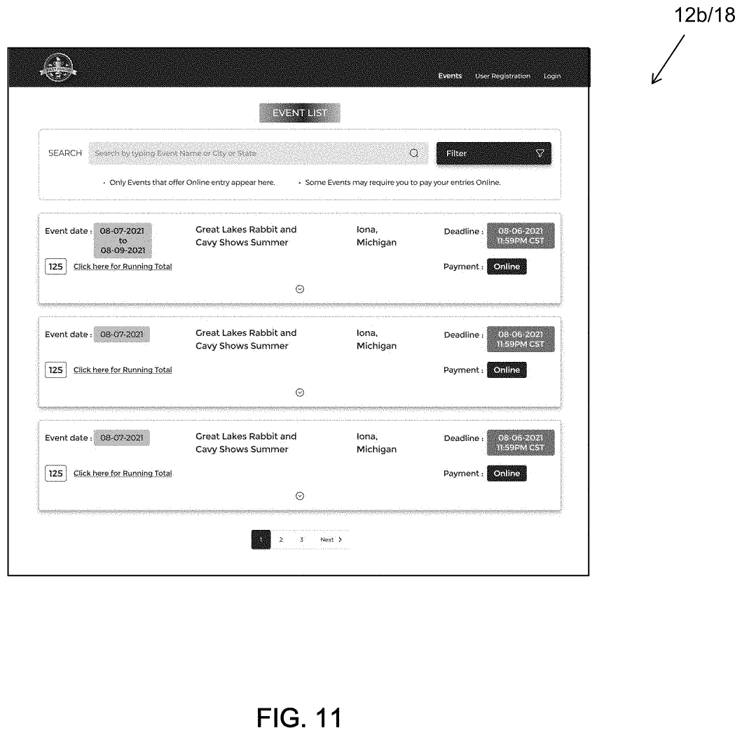

FIG. 12 shows a screen shot view of an example graphical user interface for an exhibitor host front-end system shown in FIG. 11, in accordance with one or more embodiments; the view showing an example information panel that is displayed when a user selects to view running totals for an particular event using the interface shown in FIG. 11; the information panel showing some more detailed information for an event that was selected by a user including, in this example, entry number for different breeds/categories in the event.

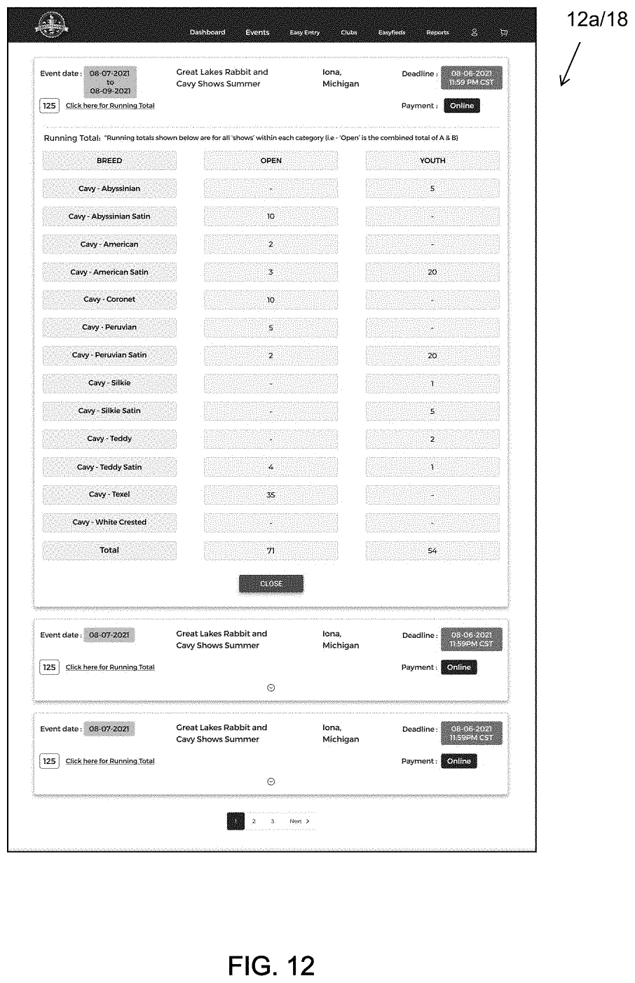

FIG. 13 shows a screen shot view of an example graphical user interface for an exhibitor host front-end system, in accordance with one or more embodiments; the view showing an example interface screen for exhibitor users to input and store a number of animals for quick and easy entry into events; the interface screen having data fields permitting users to specify various data metrics for each animal such as: ownership, ear number, breed, variety, class, sex, exhibitor age category, among other data.

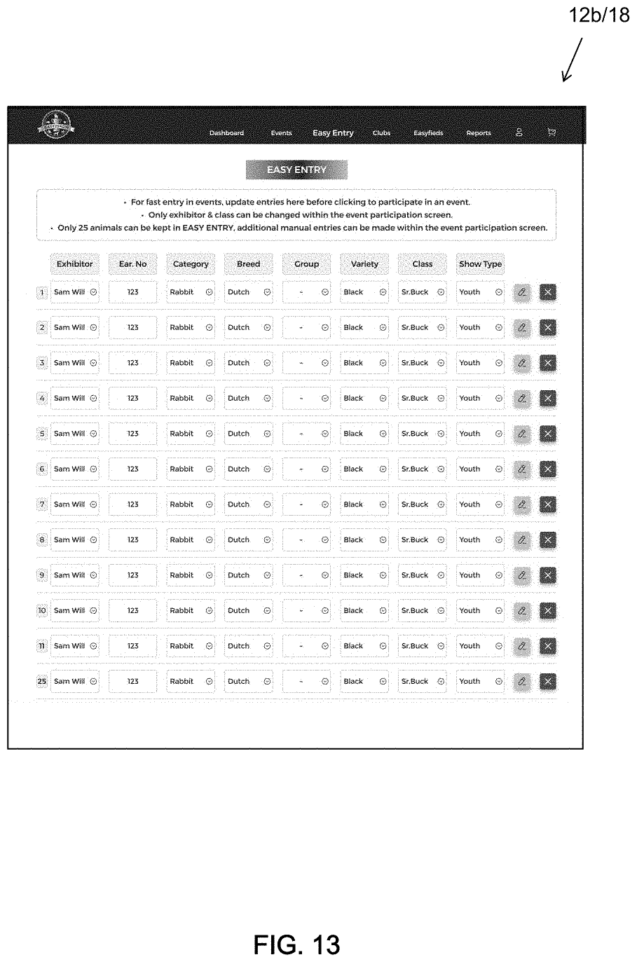

FIG. 14 shows a screen shot view of an example graphical user interface for an exhibitor host front-end system, in accordance with one or more embodiments; the view showing an example interface screen for exhibitor users to search for and view information on and register for upcoming events; the interface screen having “participate” buttons for users to select events they wish to enter; the interface screen having an “easy entry” button to permit user to select from the animals entered in the interface screen shown in FIG. 12 and revise information for selected animals, and/or add additional classes and/or contest for selected animals to participate.

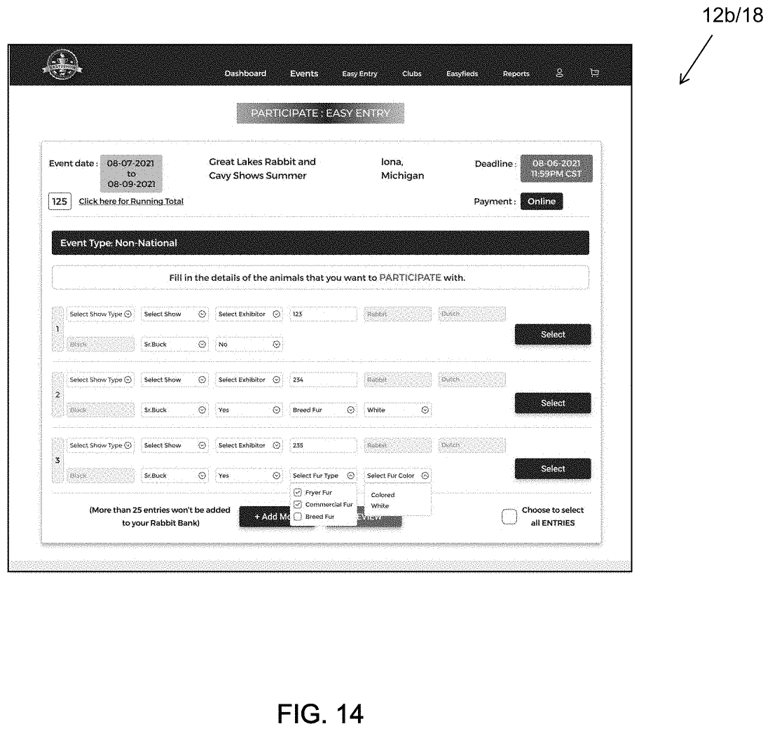

### DETAILED DESCRIPTION

In the following detailed description of the embodiments, reference is made to the accompanying drawings which form a part hereof, and in which is shown by way of illustration specific embodiments in which the disclosure may be practiced. The embodiments of the present disclosure described below are not intended to be exhaustive or to limit the disclosure to the precise forms in the following detailed description. Rather, the embodiments are chosen and described so that others skilled in the art may appreciate and understand the principles and practices of the present disclosure. It will be understood by those skilled in the art that various changes in form and details may be made without departing from the principles and scope of the disclosure. It is intended to cover various modifications and similar arrangements and procedures, and the scope of the appended claims therefore should be accorded the broadest interpretation so as to encompass all such modifications and similar arrangements and procedures. For instance, although aspects and features may be illustrated in or described with reference to certain figures or embodiments, it will be appreciated that features from one figure or embodiment may be combined with features of another figure or embodiment even though the combination is not explicitly shown or explicitly described as a combination. In the depicted embodiments, like reference numbers refer to like elements throughout the various drawings.

It should be understood that any advantages and/or improvements discussed herein may not be provided by various disclosed embodiments, or implementations thereof. The contemplated embodiments are not so limited and should not be interpreted as being restricted to embodiments which provide such advantages or improvements. Similarly, it should be understood that various embodiments may not address all or any objects of the disclosure or objects of the disclosure that may be described herein. The contemplated embodiments are not so limited and should not be interpreted as being restricted to embodiments which address such objects of the disclosure. Furthermore, although some disclosed embodiments may be described relative to specific materials, embodiments are not limited to the specific materials or apparatuses but only to their specific characteristics and capabilities and other materials and apparatuses can be substituted as is well understood by those skilled in the art in view of the present disclosure.

It is to be understood that the terms such as “left, right, top, bottom, front, back, side, height, length, width, upper, lower, interior, exterior, inner, outer, and the like as may be used herein, merely describe points of reference and do not limit the present disclosure to any particular orientation or configuration.

As used herein, “and/or” includes all combinations of one or more of the associated listed items, such that “A and/or B” includes “A but not B,” “B but not A,” and “A as well as B,” unless it is clearly indicated that only a single item, subgroup of items, or all items are present. The use of “etc.” is defined as “et cetera” and indicates the inclusion of all other elements belonging to the same group of the preceding items, in any “and/or” combination(s).

As used herein, the singular forms “a,” “an,” and “the” are intended to include both the singular and plural forms, unless the language explicitly indicates otherwise. Indefinite articles like “a” and “an” introduce or refer to any modified term, both previously introduced and not, while definite articles like “the” refer to a same previously introduced term; as such, it is understood that “a” or “an” modify items that are permitted to be previously introduced or new, while definite articles modify an item that is the same as immediately previously presented. It will be further understood that the terms “comprises,” “comprising,” “includes,” and/or “including,” when used herein, specify the presence of stated features, characteristics, steps, operations, elements, and/or components, but do not themselves preclude the presence or addition of one or more other features, characteristics, steps, operations, elements, components, and/or groups thereof, unless expressly indicated otherwise. For example, if an embodiment of a system is described at comprising an article, it is understood the system is not limited to a single instance of the article unless expressly indicated otherwise, even if elsewhere another embodiment of the system is described as comprising a plurality of articles.

It will be understood that when an element is referred to as being “connected,” “coupled,” “mated,” “attached,” “fixed,” etc. to another element, it can be directly connected to the other element, and/or intervening elements may be present. In contrast, when an element is referred to as being “directly connected,” “directly coupled,” “directly engaged” etc. to another element, there are no intervening elements present. Other words used to describe the relationship between elements should be interpreted in a like fashion (e.g., “between” versus “directly between,” “adjacent” versus “directly adjacent,” “engaged” versus “directly engaged,” etc.). Similarly, a term such as “operatively”, such as when used as “operatively connected” or “operatively engaged” is to be interpreted as connected or engaged, respectively, in any manner that facilitates operation, which may include being directly connected, indirectly connected, electronically connected, wirelessly connected, or connected by any other manner, method or means that facilitates desired operation. Similarly, a term such as “communicatively connected” includes all variations of information exchange and routing between two electronic devices, including intermediary devices, networks, etc., connected wirelessly or not. Similarly, “connected” or other similar language particularly for electronic components is intended to mean connected by any means, either directly or indirectly, wired and/or wirelessly, such that electricity and/or information may be transmitted between the components.

It will be understood that, although the ordinal terms “first,” “second,” etc. may be used herein to describe various elements, these elements should not be limited to any order by these terms unless specifically stated as such. These terms are used only to distinguish one element from another; where there are “second” or higher ordinals, there merely must be a number of elements, without necessarily any difference or other relationship. For example, a first element could be termed a second element, and, similarly, a second element could be termed a first element, without departing from the scope of example embodiments or methods.

Similarly, the structures and operations discussed herein may occur out of the order described and/or noted in the figures. For example, two operations and/or figures shown in succession may in fact be executed concurrently or may sometimes be executed in the reverse order, depending upon the functionality/acts involved. Similarly, individual operations within example methods described below may be executed repetitively, individually or sequentially, to provide looping or other series of operations aside from single operations described below. It should be presumed that any embodiment or method having features and functionality described below, in any workable combination, falls within the scope of example embodiments.

As used herein, various disclosed embodiments may be primarily described in the context of an animal show type event. However, the embodiments are not so limited. It is appreciated that the embodiments may be adapted for use in other applications and/or systems, which may be improved by the disclosed structures, arrangements and/or methods. The system is merely shown and described in the context of animal show events for ease of description and as one of countless examples.

### System 10:

With reference to the figures, a system for management of events 10 (or simply system 10) is presented. System 10 is formed of any suitable design, arrangement, and circuitry and is configured to facilitate performance of various tasks associated with hosting of events including but not limited to, for example, setup and configuration of event and participation by host, sanctioning club(s), and exhibitors, purchase of club sanctioning, registration of exhibitors, scoring/judging of competitions, and/or reporting of results to exhibitors and sanctioning clubs.

In one or more arrangements, the system 10 includes a set of front-end system 12 and a back-end system 14 among other components. The front-end system 12 are communicatively connected to the back-end system 14 over one or more data networks 16.

### Front-End Systems 12

In one or more arrangements, system 10 includes a set of front-end systems 12. Front-end systems 12 are formed of any suitable design, arrangement, and circuitry and are configured to provide a graphical user interface 18 for end users to communicate with back-end system 14 to input, access to, and processing of data stored therein and/or perform various operations related to setup and/or management of an event.

In the arrangement shown, as one example, system 10 includes three front-end systems 12 for use by the different types of end-users. In this example arrangement, system 10 includes an event host front-end system 12a, an exhibitor front-end system 12b, and a club front-end system 12c. However, the embodiments are not so limited. Rather, it is contemplated that in some various arrangements, system 10 may include any number of front-end systems 12 configured for access by various categories of end users.

Event host front-end system 12a is formed of any suitable size, shape, or design and is configured to provide a graphical user interface for the event host to input, access, and process data using back-end system 14 to facilitate initial creation of events, mapping layout of events, marketing of events, processing of exhibitor applications, application and/or payment for club sanctioning of events, scoring of competitions, finalizing and reporting results, and/or tracking of data for sanctioning clubs, among other operations related to setup and/or management of events.

Exhibitor front-end system 12b is formed of any suitable size, shape, or design and is configured to provide a graphical user interface for exhibitors to input, access, and process data using back-end system 14 to facilitate review and/or marking of upcoming events, registration for events, submission of payments, and/or review of results, among other operations related to participation and/or attendance of events.

Club front-end system 12c is formed of any suitable size, shape, or design and is configured to provide a graphical user interface for clubs to input, access, and process data using back-end system 14 to facilitate review and/or approval of applications, configuration of reporting and other requirements of the club, review of event results, and/or configure and review club data tracked by system 10, among other operations related to club sanctioning of and/or member participation in events.

Graphical user interface(s) 18 provided by front-end systems 12 may be formed of any suitable size, shape, design, and/or technology and is configured to permit end users to interact with back-end system 14 to facilitate input, access to, and processing of relevant data to facilitate setup and/or management of an event. In one or more arrangements, as one example, one or more graphical user interface(s) 18 of front-end systems 12 may be provided by, for example, execution of a local application on a personal electronic device (e.g., a smartphone, tablet, laptop, wearable device, and/or or other computing or electronic device). Additionally or alternatively, in one or more arrangements, one or more graphical user interface(s) 18 may be provided by web-based application executed in a web browser. Such web application may be, for example, a web portal hosted by a web server on back-end system 14 or by a third-party service provider. Additionally or alternatively, in one or more arrangements, one or more graphical user interface(s) 18 may be provided by a program executed on a computer or other electronic device communicatively connected to back-end system 14.

### Back-End System 14:

Back-end system 14 is formed of any suitable size, shape, design and is configured to communicate with front-end systems 12 to facilitate input and accessing of relevant event data by users and perform various operations relating to setup and management of events. In the arrangement shown, as one example, back-end system 14 includes a database 20 and a data processing system 30, among other components.

### Database 20:

Database 20 is formed of any suitable size, shape, design and is configured to facilitate storage and retrieval of data. In the arrangement shown, as one example, database 20 is local data storage connected to data processing system 30 (e.g., via a data bus or electronic network). However, embodiments are not so limited. Rather, it is contemplated that in one or more arrangements, database 20 may be remote storage or cloud-based service communicatively connected to data processing system 30 via one or more external communication networks. Moreover, in one or more arrangements, database may be integrated into data processing system 30.

### Data Processing System 30:

Data processing system 30 is formed of any suitable size, shape, and design and is configured to facilitate communication with front-end systems 12, storage and/or retrieval of event data in database 20, and/or execution of management processes 24 for performance of various operations related to setup, management, and/or execution of events, among other processes performed by system 10.

In one or more arrangements, for example, such data processing system 30 includes a circuit specifically configured and arranged to carry out one or more of these or related operations/activities. For example, data processing system 30 may include discreet logic circuits or programmable logic circuits configured for implementing these operations/activities, as shown in the figures, and/or described in the specification. In certain embodiments, such a programmable circuit may include one or more programmable integrated circuits (e.g., field programmable gate arrays and/or programmable ICs). Additionally or alternatively, such a programmable circuit may include one or more processing circuits (e.g., a computer, microcontroller, system-on-chip, smart phone, server, and/or cloud computing resources). For instance, computer processing circuits may be programmed to execute a set (or sets) of instructions (and/or configuration data). The instructions (and/or configuration data) can be in the form of firmware or software stored in and accessible from a memory (circuit). Certain embodiments are directed to a computer program product (e.g., nonvolatile memory device), which includes a machine or computer-readable medium having stored thereon instructions, which may be executed by a computer (or other electronic device) to perform these operations/activities.

In one or more arrangements, data processing system 30 includes a processing circuit 32 and memory 34 having software code 36 or instructions that facilitates the processing and/or display of information, and a communication circuit 38, among other components.

Processing circuit 32 may be any computing device that receives and processes information and outputs commands according to software code 36 or instructions stored in memory 34. Memory 34 may be any form of information storage such as flash memory, ram memory, dram memory, a hard drive, or any other form of memory. Processing circuit 32 and memory 34 may be formed of a single combined unit. Alternatively, processing circuit 32 and memory 34 may be formed of separate but electrically connected components. Alternatively, processing circuit 32 and memory 34 may each be formed of multiple separate but electrically connected components.

Software code 36 or instructions is any form of information or rules that direct processing circuit 32 how to receive, interpret, and respond to information to operate as described herein. Software code 36 or instructions is stored in memory 34 and accessible to processing circuit 32. As an illustrative example, in one or more arrangements, software code or instructions may configure processing circuit 32 to interact with users via front-end systems 12 and perform various event management processes 24 in response to user input.

### Communication Circuit 38:

Communication circuit 38 is formed of any suitable size, shape, design, and/or technology and is configured to facilitate communication with back-end system 14. In one or more arrangements, as one example, communication circuit 38 includes a transceiver circuit and an antenna. A transceiver is any electronic device that facilitates two-way communication, that is, the delivery of information between data processing system 30 and other components of the system 10. An antenna is any device that is configured to receive wireless signals from over-the-air communication and/or transmit wireless signals in over-the-air communication. In an example arrangement, a transceiver of communication circuit 38 is connected with a respective antenna, which may be a monopole antenna, dipole antenna, a loop antenna, a fractal antenna, or any other form of an antenna, to facilitate transmission and/or reception of signals in the form of electromagnetic radio frequencies. Additionally or alternatively, the transceiver of communication circuit 38 may be configured to communicate over a wired communication channel.

In various arrangements, communication circuit 38 may be configured to communicate with various components of system 10 using various wired and/or wireless communication technologies and protocols over various networks and/or mediums including but not limited to, for example, Serial Data Interface 12 (SDI-12), UART, Serial Peripheral Interface, PCI/PCIe, Serial ATA, ARM Advanced Microcontroller Bus Architecture (AMBA), USB, Firewire, RFID, Near Field Communication (NFC), infrared and optical communication, 802.3/Ethernet, 802.11/WIFI, Wi-Max, Bluetooth, Bluetooth low energy, UltraWideband (UWB), 802.15.4/ZigBee, ZWave, GSM/EDGE, UMTS/HSPA+/HSDPA, CDMA, LTE, 4G, 5G, FM/VHF/UHF networks, and/or any other communication protocol, technology or network.

Although system 10 is primarily shown and discussed with reference to a single back-end system 14, the arrangements are not so limited. Rather, it is contemplated that back-end system 14 may be formed a multiple separate systems that are communicatively connected together. In some various arrangements, such interconnected back-end systems 14 may be configured to perform all processes discussed herein or may perform a subset of the processes. For example, in one or more arrangements, system 10 may include a first back-end system 14 configured to perform back-end processes for event hosts, a second back-end system 14 configured to perform back-end processes for exhibitors, and a third back-end system 14 configured to perform back-end processes for clubs. Any other computing architecture or computing arrangement for back-end system 14 is also contemplated.

### Management Processes 24 of Back-End System 14:

In one of more arrangements, data processing system 30 of back-end system 14 is configured to execute one or more management processes 24. Management processes 24 are configured to perform various operations related to the setup, management, and/or execution of events in response to input from users via front-end systems 12. For example, in one or more arrangements, management process 24 may include but are not limited to: event setup and monitoring 24a, club sanctioning 24b, payments 24c, event marketing 24d, exhibitor registration and check-in/check-out 24e, sales 24f, judging 24g, results reporting 24h, club tracking and support 24i, among other operations. In some arrangements, various different management processes may involve user input and interaction via a single front-end system 12 or may involve user input and interaction via multiple front-end systems 12, which is coordinated by back-end system 14.

### Event Setup and Monitoring 24a:

Events are typically set up and coordinated by a representative of the event host, who is commonly referred to as a secretary. In one or more arrangements, a secretary for an event host may subscribe to or purchase access to system 10 via the event host front-end system 12a, where they set up a profile (e.g., indicating their name, address, email, club name, username and/or password).

Following registration with the system 10, the secretary for the event host may utilize the event host front-end system 12 to create new events. In one or more arrangements, event host front-end system 12 may provide a graphical user interface configured to guide the secretary through creation of new events for different types of events (e.g., trade show, sporting competition, animal exhibition, etc.) and various options associated therewith.

In one or more arrangements, event host front-end system 12a is configured to adjust available, default, and/or suggested event options based on the input information and/or selected options. For example, if a secretary creates a new animal exhibition type event, the event host front-end system 12 may prompt the secretary to specify the species of animal(s) that will be exhibited and dynamically adjust default and/or suggested options to match typically standards for the exhibitions of the selected species.

For some various different types of events, event host front-end system 12a may provide the secretary of the event host predefined options for various types of competitions, awards, lotteries, giveaways, and/or participant activities that may be common for the selected type of event. However, the secretary of the event host may additionally or alternatively manually define competitions, awards, lotteries, giveaways, and/or participant activities for the created event via event host front-end system 12a.

In one or more arrangements, event host front-end system 12a permits the secretary of the event host to specify criteria, restrictions, and/or other settings for attendance and/or for registration/participation in selected competitions, awards, lotteries, giveaways, and/or participant activities. As some non-limiting examples, the secretary of the event host may require certain age, experience level, certification/licensure, membership, fee payment, club ranking/standing, residency or other any other requirement as prerequisite for registration for a particular competition, award, lottery, giveaway, and/or activity. For example, in one or more arrangements, event host front-end system 12a is configured to provide a map interface permitting the secretary for the event host to define quarantine zones so as to prevent exhibition of animals from certain areas where outbreaks are located.

After creation of the event, the secretary for the event host may input, access, and/or edit various information for the event and configure options via the event host front-end 12a. Information for the event may include, but is not limited to, for example, event locations, dates, schedules, invited and/or registered exhibitors, vendors or other attendees, contractors/workers for event, club information, mapping and/or layout, and/or any other information for the event. However, the arrangements are not so limited. Rather, various event information may be additionally or alternatively be input to system 10 by other management processes 24 and/or by other end users via other front-end systems 12. As information for an event is input by any of the front-end systems 12, event setup and monitoring processes 24a of back-end system 14 updates relevant information used by other front-end systems 12 and/or processes 24 as appropriate.

### Club Sanctioning 24b:

In one of more arrangements, data processing system 30 of back-end system 14 is configured to perform a club sanctioning process 24b to facilitate application, payment, and approval of sanctioning of the event by one or more clubs. In one or more arrangements, the event host front-end 12a provides a graphical user interface for the secretary for the event host to select and/or specify a set of clubs that are desired to sanction the event. In one or more arrangements, in response to the user selecting/specifying the set of clubs, club sanctioning process 24b automatically submits applications for sanctions of the event to the selected/specified clubs. In one or more arrangements, the secretary for the event host may additionally or alternatively manually apply for sanctions outside of system 10 and upload information for manually submitted applications and/or approved sanctions into system 10 using event host front-end interface 12a.

Depending on the club, club sanctioning process 24b may submit applications to an online portal/website, emails, facsimile number, and/or various other means or methods that may be specified by the clubs for submission of applications for sanctions. If a club only accepts applications for sanction via a mailing address, club sanctioning process 24b may be configured to print or otherwise provide the requisite application with information filled to the secretary for the event host for mailing to the club. In one or more arrangements, the event host front-end 12a may permit the secretary to select the desired method for club sanctioning process 24b to submit applications to clubs if multiple methods are available.

In one or more arrangements, club sanctioning process 24b may provide applications for sanctions to clubs that are registered with system 10 via club front-end system 12c. For example, in one or more arrangements, club front-end system 12c may provide a graphical user interface configured to provide an administrator or other end-user for the club to view and approve sanctions applications (if not automatic upon payment), receive payment(s) for sanctions, specify club event requirements for sanctions (e.g., fees, membership, special awards, judging criteria, and/or requirements for reporting results to the club), and/or view member participation and results of sanctioned events.

As previously mentioned, following application for sanction from a club, the event host must typically wait for to receive a response from the clubs with a sanction number or other confirmation indicating sanctioning of the event was approved. In one or more arrangements, the club sanctioning process 24b is configured to monitor applications for club sanctions and flag applications for which a sanction number has not been received or otherwise input into system 10 after a threshold period of time (e.g., a time period specified in user preferences by the secretary). For example, in one or more arrangements, club sanctioning process 24b may cause event host front-end 12a to display a notification indicating sanction applications that are overdue for approval for the secretary of the event host to follow up. Additionally or alternatively, event host front-end 12a may communicate a message with such notification of sanction applications that are overdue for approval to the secretary (e.g., via email, text message, or any other method or means for messaging). In this manner, club sanctioning process 24b reduces the time and effort required for application and monitoring of application for sanctioning by clubs. In one or more arrangements, the secretary of the event host may adjust notification settings/preferences for the club sanctioning process 24b using the event host front-end 12a.

After a sanctions number for an applied for club sanction is received or input into system 10, the management processes 24 are configured to identify the sanctions number on event materials that indicate the event is sanctioned by the club as well as on reporting of results of the event to the club. This eliminates the manual work by the competition secretary to manage appropriate placement of the sanctions number and reporting of competition results.

In one or more arrangements, club sanctioning process 24b may be configured to additionally or alternatively monitor any requirements that are specified by club for sanctioning and generate a notification (e.g., notification in event host front-end system 12a, email, text, and/or any other method for communication) to the secretary for the event host in response to unfulfilled requirements coming due or being overdue. For example, some clubs may require that competition results be reported within a certain period of time after the event has ended. Some clubs may not sanction additional events of an event host if requirements for previous sanctioned events have not been completed. In one or more arrangements, club sanctioning process 24b may be configured to notify the secretary of overdue requirements (if any) when the club is selected for sanctioning of a new event.

As another example, some clubs require a per entry payment in addition to or include of an event sanction fee. In one or more arrangements, back-end system 14 is configured to calculate the amounts due to clubs for per entry fees (if any are required by the club) at the end of the competition, generate appropriate reporting for the per entry fees for the secretary of the event host to submit to the club(s) with payment. Additionally, in some arrangements, club sanctioning process 24b may prompt payment process 24c to automatically submit payments of sanctions fees and/or per entry fees to clubs.

### Payments Process 24c:

In one of more arrangements, the management processes 24 performed by data processing system 30 of back-end system 14 includes a payments process 24c configured to facilitate payments between exhibitors (or other attendees), event host, and clubs sanctioning the event. In one or more arrangements payment process 24c is configured to initiate payment transactions using one or more commercial third-party payment processors. However, the embodiments are not so limited. Rather, it is contemplated that in some arrangements, payments process 24c may utilize various other methods to transfer amounts between exhibitors (or other attendees), event host, and clubs sanctioning the event. For instance, in some arrangements, payments process 24c may coordinate transfers of amounts between accounts maintained by payments process 24c for users.

Additionally or alternatively, in one or more arrangements, payments process may collect various fees from event host for a subscription to use the system 10 generally. For example, in one or more arrangement, event hosts may be charged a fee for each event they wish to create and manage using system. In some arrangements, system 10 may additionally or alternatively be configured to collect fees from event host for use of certain particular services. However, the arrangements are not so limited. Rather, it is contemplated that in various arrangements event hosts may be provided access to system and/or features using any fee structure or pricing model.

### Event Marketing Process 24d:

In one of more arrangements, the management processes 24 performed by data processing system 30 of back-end system 14 includes an event marketing process 24d configured to market an event to potential exhibitors (or other possible attendees) when the event is ready to open for registration. In one of more arrangements, event host front-end system 12a is configured to provide a graphical user interface for the secretary of the event host to select and configure marketing to be performed by event marketing process 24d for the event. For example, in some various arrangements, event marketing process 24d may be configured to communicate invitations and/or notifications of the event to exhibitors of one or more similar previous events (e.g., via email, text messaging, push notifications, exhibitor front-end system 12b, mailing, and/or any other method for communication). In some arrangements, system 10 may additionally or alternatively permit an event host to communicate invitations and/or notifications of the event to members of clubs that are sanctioning the event. In some arrangements, system 10 may additionally or alternatively permit an event host to communicate invitations and/or notifications to exhibitors/attendees of similar events previously hosted by other event hosts. For example, in some arrangements, system 10 may maintain aggregated lists of exhibitors and/or other attendees for different types of events and permit other event hosts to market similar events to such exhibitors/attendees under certain circumstances. For example, in one or more arrangements, event marketing process 24d may permit an event host to market to exhibitors/attendees on an aggregated list for the type of event if the event host consents to permit exhibitors/attendees of events of the event host to be added to the aggregated list. In some other arrangements, event marketing process 24d may permit an event host to market to exhibitors/attendees on an aggregated list for a fee. However, the embodiments are not so limited. Rather, it is envisioned that event marketing process 24d may market the event to potential exhibitors/attendees using various other known methods and means for marketing including but not limited to (mailers, emails, text, push notifications, online advertising and/or postings, and/or any other method or means for marketing.

### Exhibitor Registration and Check-In/Checkout 24e:

In one of more arrangements, the management processes 24 performed by data processing system 30 of back-end system 14 includes a process 24e for registration, check-in, and check-out of exhibitors. In one or more arrangements, exhibitor front-end system 12b is configured to provide a graphical user interface for exhibitors or other attendees to view and register for events created by event hosts.

Invitations sent to potential exhibitors/attendees by event marketing process 24d may include a link directing the potential exhibitors/attendees to a specific portal for the event provided by the exhibitor front-end system 12b. The event portal provided by exhibitor front-end system 12b may provide various information and/or materials for the event including but not limited to, for example, dates, times, location, secretary info, event host info, sanctioning clubs, entry fees, competitions/classes, entry requirements, awards, judges, rules, brochures, flyers, schedules, maps, and/or any other information related to the event.

In one or more arrangements, exhibitor front-end system 12b provides an interface for prospective exhibitors/attendees to create a profile (if new user), register to attend an event, enter into competitions of the event, and/or sign up for or reserve slots for various activities at the event. In one or more arrangements, process 24e is configured to ensure the exhibitors/attendees satisfies prerequisites/requirements (if any) for selected events, competitions, and/or activities using data in exhibitor/attendee profiles and other data stored in database 20 or third-party data sources (e.g., Club databases). For example, a club that is sanctioning an event may require membership of exhibitor/attendee (or membership of the animal to be entered) to compete for special awards awarded by the club.

In one or more arrangements, if process 24e is unable to access information to verify requirements, the secretary for the event host may be notified to manually review and confirm whether or not requirements are met. Once confirmed, process 24e notifies the exhibitor/attendee whether requirements were confirmed and, if so, is allowed to complete registration of entries.

In one or more arrangements, exhibitor front-end system 12b provides an interface for exhibitors/attendees to submit payment for selected events, competitions, and/or activities for which the exhibitors/attendees wish to register. In the arrangement shown, as one example, payments are processed using payments process 24c executed by data processing system 30. It is recognized that different events may have different payment structures. As a few illustrative examples, some exhibition events may charge separate/different fees for different classes or particular competitions, while some other exhibition events may allow exhibitors to enter as many classes or competitions as they wish for a flat fee, and yet some other exhibition events may charge fees for each entry to be submitted for competition. In one or more arrangements, the secretary for the event host may set fees to be charged for the event using the event host front-end system 12a.

In one or more arrangements, exhibitor front-end system 12b may be additionally of alternatively configured to provide an interface for exhibitors/attendees to apply and submit payment for required club memberships (e.g., using payments process 24c). For example, if an exhibitor attempts to register to compete for an award requiring club membership, the process 24e may check-in database 20 or access a separate system 30 for the club to determine whether or not the exhibitor is a current club member. In one or more arrangements, if the exhibitor is already a member of the club but does not have a profile set up in front-end system 12b, process 24e will pull their membership information and use it to create a profile for the exhibitor after the exhibitor verifies the information is correct.

If the exhibitor is not a current member of the club, process 24e may retrieve information from the exhibitor from a profile of the exhibitor stored in database 20 and have the exhibitor verify the information is correct or have the exhibitor input the required information using front-end system 12b. In this example, process 24e will then submit an application for membership and initiate payment for the membership from the exhibitor to the club. Once the payment for membership is made, a pre-determined custom fillable welcome letter, membership card or other type of correspondence is automatically sent to the new member via email and the profile for the exhibitor is updated to indicate the exhibitor is a member of the club. In this manner, the need for someone at the club to manually process a membership request is eliminated. This process additionally provides immediate registration permitting the exhibitor to proceed with registration for the event.

In response to registration by an exhibitor/attendee using front-end system 12b, process 24e automatically enters the exhibitor/attendee into the selected event, competition, or activity without involvement of the secretary of the event host. In one or more arrangements, exhibitor front-end system 12b provides real time entry numbers for events, competitions, or activities, broken down by classes for viewing by the exhibitors/attendees.

In one or more arrangements, after an exhibitor/attendee has completed registration process 24e generates a check-in/check-out sheet for the exhibitor/attendee for the event. For an animal exhibition event, the check-in sheet may indicate animals that the exhibitor has registered for the event. This helps exhibitors/attendees bring and leave with the correct entries (e.g., animals). The check-in/check-out sheet also helps event workers mitigate theft by ensuring that animals are only taken if they are listed on the check-in/check-out sheet or on a bill of sale (e.g., if purchased at the event). In one or more arrangements, exhibitors/attendees may access their check-in/checkout though exhibitor front-end system 12b (e.g., via a smartphone, laptop of other personal electronic device) to avoid the need to carry a physical copy of the check-in/check-out sheet. In one or more arrangements, exhibitor front-end system 12b permits exhibitors to make changes to entries up to the competitions designated deadlines (if any have been set by the secretary of the event host via the event host front-end system 12a). In response to changes by an exhibitor/attendee, process 24e updates entries for the event and provides the exhibitor/attendee an updated check-in sheet for the event. At any time, exhibitors/attendees can retrieve and review registrations/entries from their user profile.

### Sales 24f:

In one of more arrangements, the management processes 24 performed by data processing system 30 of back-end system 14 includes a sales process 24f to facilitate sales of items at or prior to an event. In some arrangements, exhibitor front-end system 12b may permit the exhibitors/attendees to purchase various items for the event, e.g., parking permits, banquet tickets, elevated access badges, event branded merchandise and/or any other items related to the event. Additionally or alternatively, in some arrangements, exhibitor front-end system 12b may permit exhibitors/attendees to browse and/or purchase items and/or merchandise offered for sale by third party vendors, exhibitors, or other attendees at the event and/or prior to the event. For instance, in one or more arrangements, exhibitor front-end system 12b provides an interface for an exhibitor or other attendee to list items that they wish to offer for sale at the event and/or make the items available for advance order and/or purchase (e.g., for purchase and/or pickup at the event).

In one or more arrangements, items listed for sale may be associated with respective identifier (e.g., QR codes) that may be attached to the items to facilitate and verify sales of items at the event. As an illustrative example, exhibitor Jane Doe may list a number of rabbits for sale at a rabbit exhibition event. To perform a sales transaction of one of the rabbits (Rabbit A) to Jim Smith at the event, Jane Doe enters an identifier (e.g., username, email, QR code, or other identifier) for Jim Smith using the exhibitor front-end system 12b.

Jane then scans or enters an identifier on a tag on rabbit A and selects the animal from her list of items for sale in exhibitor front-end system 12b. In response, sales process 24f provides an alert that there is a pending sale to Jim Smith (e.g., in exhibitor front-end system 12b, text message, email or other method for notification). Jim Smith may then accept or decline the transaction in the exhibitor front-end system (e.g., by clicking on a link or button in the alert). Upon Jim Smith accepting the transaction, sales process 24f records the transaction and updates the check-in/checkout sheets of Jane Doe and Jim Smith to reflect the purchase of Rabbit A and prompts payment process 24c to provide payment from Jim Smith to Jane Doe according to payment settings in Jim Smith's and Jane Doe's profiles. In one or more arrangement, sales process 24f may additionally or alternatively be used to record sales and update check-in/checkout sheets for sale with payment made outside of the system (e.g., cash, check, or a third party payment system). In some arrangements, sales process 24f is additionally or alternatively configured to conduct auctioning of items listed for sale. This feature may be useful at livestock shows, for example, wherein animals are often auctioned after judging. In one or more arrangements, sales process 24f may be configured (e.g., by the secretary for the event host) to automatically collect a fee for the event host and/or sales tax for sales and/or auction transactions conducted using sales process 24f.

Notwithstanding the above example sale, in one or more arrangements, system 10 is configured to credit Jane Doe for participation and any awards given to Rabbit A during the event despite selling Rabbit A during the event. However, the embodiments are not so limited. Rather, it is contemplated that in one or more arrangements, the secretary for the event host may configure system 10 to allocate participation credit and any awards differently when sales are transacted during the event.

In one or more arrangements, sales process 24f may be configured to transfer information for a purchased animal (or item) to the buyer. Such information may include but is not limited to, for example, breed, pedigree, age, gender, vaccination/medical information and/or any other relative information. Such transfer is thought to be particularly useful for breeders who purchase animals at exhibitions. In some various arrangement, the transfer performed by sales process 24f may make the information available to the buyer via the exhibitor front-end system 12a. However, the embodiments are not so limited. Rather, it is contemplated that transfer of the information to the buyer may be accomplished using various methods or means including but not limited to, for example: email, facsimile, text, weblink or any other method or means for communication.

In one or more arrangements, sales process 24f is configured to permit unattended sales of items during an event. This capability may be particularly advantageous as it can permit attendees to make sales without needing to maintain a presence at a table or booth during the event. For example, an animal exhibition event may be setup to have a designated “sales areas” at which animals (or other items) that are not entered for competitions are brought for sale only. In such case, the owner would not have to be present for the sale. Rather, the buyer may scan or enter an identifier for the desired item to purchase in the exhibitor front-end system 12b and submit a request for purchase. In response, sales process 24f provides an alert that there is a pending sale to the seller (e.g., in exhibitor front-end system 12b, text message, email or other method for notification). The seller may then accept or decline the transaction (e.g., by clicking on a link or button in the alert). Upon both parties accepting the transaction, sales process 24f records the transaction and updates the check-in/checkout sheets of the buyer and seller to reflect the purchase.

It is not uncommon for some events to request/allow exhibitors/attendees to sponsor sanction fees and awards for the event. In one or more arrangements, exhibitor front-end system 12b is configured by the secretary of the event host (e.g., via event host front-end system 12a) to allow exhibitors/attendees to purchase sponsorships for the event using the sales process 24f For instance, in one or more arrangements, sponsorships available for purchase may be listed along with other items available for purchase in exhibitor front-end system 12b if the event host selects to offer sponsorships for sale.

Additionally or alternatively, in one or more arrangements, exhibitor front-end system 12b may market available sponsorships on web pages for an upcoming event. For instance, in one or more arrangements, exhibitor front-end system 12b may provide a drop-down menu (or other listing) indicating what club sanctions and/or awards require sponsorship and how much money is still needed to fully pay for the club sanctions and/or awards. The exhibitor front-end system 12b may permit the potential exhibitor/attendee to purchase one or more sponsorships using the sales process 24f as previously described. In one or more arrangements, sales process 24f maintains a list of sponsorship purchasers for use with adverting/marketing for the event to give appropriate credit and thanks to sponsors.

### Judging 24g:

After the entry deadline specified by the event host has passed, the exhibitor front-end system 12b disables the ability to submit additional registrations for the event. However, in one or more arrangements, the secretary for the event host may manually enter new registrations or make manual change to an entry if required for some reason. For exhibition type events, system 10 has already sorted entries by class and/or particular competition and exhibition event is ready to begin as scheduled.

In one or more arrangements, system is configured to generate scoring cards for use by judges to enter data and comments for scoring competition entries which may be printed prior to the event or may be electronically accessed and filled by judges using a graphically user interface provided by the system 10. In some various arrangements, such graphical user interface may be provided, for example, by a web portal hosted by event host front-end system 12a (or another component of system 10) and accessed by personal electronic devices of judges. However, the arrangements are not so limited. Rather, it is contemplated that a graphical user interface for entry of scoring and comments by judges may be implemented using various other arrangements (e.g. by an app downloaded to personal electronic device). In one or more arrangements, judging process 24g is configured to automatically cause data processing system 30 to store the entered score card data and comments in database 20. In this manner, the need for the secretary of the event host to manually enter score card data can be primarily eliminated.

For some events, it may be preferred for judged to fill out paper score cards. For such events, the secretary for the event host may access and print score cards from the event host front-end system 12a prior to the event. However, in some, system 10 may still avoid the need to manually data. For example, in one or more arrangements, the secretary for the event may easily scan paper score card into an electronic file (e.g., pdf) using a commercial scanner and upload the electronic file to the system 10 using event host front-end system 12a. In one or more arrangements, once uploaded, the judging process 24g performed by data processing system 30 applies optical character recognition of a similar process to extract scoring information and comments from the fields of the score cards. The extracted scoring information and comments are then stored in database 20. In one or more arrangements, once it is confirmed that scoring information and comments have been entered for all exhibitors that competed, judging process 24g may automatically tabulate the scoring information to determine preliminary rankings, placement, awards, or other results of the event.

In one or more arrangements, system 10 is configured to permit exhibitors to dynamically enter different classes or contests during an event. For example, at some smaller horse shows, exhibitors may select to pay for the number of classes that they wish to enter or they can select to pay a flat fee to participate in as many classes that they may qualify for. In some cases, where events do not have a cut off time to enter classes, the ring steward for the show may struggle to write down which exhibitors enter and then get that to the judge for placement etc. In one or more arrangements, system 10 is configured to provide a graphical user interface (e.g., provided by event host front-end system 12a or other component of system 10) for the ring steward (or other worker for an event) to easily enter a new exhibitor into a class, for example, by entering or scanning an identifier for the exhibitor and/or entry. In response, data processing system 30 would be prompted to enter the exhibitor/entry into the class and an updated list of exhibitors and/or updated score sheets would automatically be provided by judges. In this manner, judges would be ready to proceed as the gate is closed (signaling the class is closed) and he can begin to judge and place the class.

In one or more arrangements, system 10 may be configured to assist the event host with contacting and scheduling of judges in advance of an event. In one or more arrangements, event host front-end system 12a may be configured to generate lists of judges who are certified by the relevant judging association for judging of an event. Additionally or alternatively, in one or more arrangements, host front-end system 12a may allow the secretary for the event host to prompt back-end system 14 to send invitations (e.g., via email) to user selected judges to participate as a judge for the event. Additionally or alternatively, in one or more arrangements, host front-end system 12a may allow the secretary for the event host to collect bid from selected judges indicating amount the judges would require for payment. In one or more arrangements, back-end system 14 may be configured to track agreed payments and transfer payment from event host to judges following completion of the event (e.g., via payment process 24c).

### Results Reporting 24h:

In one of more arrangements, data processing system 30 of back-end system 14 is configured to perform a results reporting process 24h to facilitate reporting of results of the event to interested parties. In one or more arrangements, the secretary for the event host must review and confirm the results using event host front-end system 12a in order to finalize the results. After results are finalized, process 24h automatically publishes and/or distributes results to sanctioning clubs, exhibitors, other attendees, and/or the general public.

For example, in one or more arrangements, results reporting process 24h is configured to generate a summary of overall results of the event and post the overall results on a webpage for the event. Additionally or alternatively, in one or more arrangements, results reporting process 24h is configured to provide general results to clubs, exhibitors, other attendees, or any other parties (e.g., via email, web posts, text message, push notification, mailing, flyers, exhibitor front-end system 12b, club front-end system 12c, or any other method for communicating results).

In addition to or in lieu of general information, in one or more arrangements, process 24h is configured to provide individual results (e.g., information and comments on score cards of the exhibitors) available to the exhibitors of the event. In this example arrangement, individual results of each exhibitor are made available to the exhibitor via front-end system 12b along with results of previous events the exhibitor participated in that were hosted using system 10. However, the arrangements are not so limited. Rather, it is contemplated that individual results may be communicated to exhibitors using various means and methods including but not limited to, for example, front-end system 12b, email, web posts, text message, push notification, mailing, or any other method for communicating.

As previously mentioned, clubs that sanction events typically have requirements for reporting of results to the club. For example, typically results provided to club that issue sanctions must specify the sanctions number assigned to the event when sanction was approved. Additionally, the club-specific requirement for sanction may require special specific data metrics to be reported, for example, to enable the club to issue special awards, sweepstakes, certifications (e.g., legs), titles, member ranking/standing, and/or other information or data metrics. In one or more arrangements, results reporting process 24h is configured to retrieve requirements for reporting of results for each club that sanctioned the event from database 20 and generate a customized report for the club that specifies the general/member results information, the assigned sanctions number (if any) and/or any other club-specific information required by the sanctioning club. In one or more arrangements, results reporting process 24h may be configured to specify a national club sanction number (if applicable) for clubs that do not issue sanctions numbers. In one or more arrangements, results reporting process 24h may provide the customized report of results to the sanctioning club and/or club member using various means and methods including but not limited to, for example, club front-end system 12c, email, web posts, text message, push notification, mailing, or any other method for communicating.

Some clubs may themselves perform calculating and awarding of club-specific awards, sweepstakes, standings, rankings, or other data metrics from data in the reports received from system 10. Furthermore some clubs may calculate wins for various classes/competitions for their members only. However, in some arrangements, club front-end system 12c may permit the clubs to select to have system 10 calculate certain club-specific awards, sweepstakes, certifications (e.g., legs) titles, member rankings/standing, or other information or data metrics on the club's behalf and includes the club-specific awards, sweepstakes, standings, rankings, or other data metrics in the report. In this manner, the need for the club to make such determinations may be eliminated. Moreover, in some arrangements, clubs may select to have results reporting process 24h communicate the club-specific results directly to club members, a club web page hosted by club system 40, or any other third party or location on behalf of the club. In this manner club-specific results may be communicated to members more quickly.

In one or more arrangements, results reporting process 24h may make preliminary results accessible to exhibitors or other attendees immediately as they are input into system before results are finalized. Such release of preliminary results may make some events more suspenseful and engaging. For example, in one or more arrangements, preliminary results may be made available to exhibitors and/or other attendees of the event through exhibitor front-end system 12b. Additionally or alternatively, in one or more arrangements, the secretary for the event host may configure system 10 to post preliminary results to a webpage and/or stream preliminary results to one or more displays and/or scoreboards located at the event. However, the embodiments are not so limited. Rather, it is contemplated that results reporting process 24h may disseminate preliminary results using various means and methods including but not limited to, for example, club front-end system 12c, email, web posts, text message, push notification, mailing, or any other method for communicating.

### Club Tracking and Support 24i:

As previously discussed, clubs and other organization may track various statistics and/or data metrics on members/exhibitors to facilitate calculation and/or awarding of club-specific awards, sweepstakes, certifications (e.g., legs) titles, member rankings/standing, or various other achievement or notable information. Such tracking of data can be an overly burdensome task, particularly for smaller clubs.

Moreover, tracking of information by clubs is also prone to error. For example, in rabbit exhibition events, an entry may receive a “Leg” which is a certificate that signifies that they achieved a certain win. Other species exhibitions may use similar certificates to facilitate tracing of “special” awards, registration numbers, win “titles”, and/or other information else that club issues/tracks. For rabbit exhibitions, legs are the pathway to an animal receiving a Grand Champion certificate. For rabbit shows, the American Rabbit Breeders Association (ARBA) has a bar code program that they license to show software companies, like us, so that we can properly code the legs that our software emails out to the exhibitors. However, the ARBA does not track these bar codes. Which means, and often happens, the show secretary makes a mistake and issues Rabbit “A” a leg in error instead of Rabbit “B”. The error is found and now Rabbit “B” is issued a (the) leg. An email or phone call goes to the Rabbit A's owner, from the show secretary, saying please destroy that leg it was a mistake. There is currently no way to track if that person later turns in that leg to the ARBA to get a Grand Champion certificate on that rabbit.

In one or more arrangements, system 10 is configured to track and maintain a log of wins, awards, certificates, titles, and any other information on behalf of exhibitors, clubs, and/or organizations to ensure accuracy and correct any reported mistakes. In some various arrangements, tracked club data may be accessed by club members via the club front-end system 12c.

### Communities:

In one or more arrangements, system 10 may be configured to provide limited access to some information to a designated community of persons. In one or more arrangements, front-end systems 12 may be configured to permit exhibitors, event hosts, clubs, or other users to join and participate one or more communities of persons who participate in similar events. In some arrangements, front-end systems 12 may permits event hosts, exhibitors, and/or clubs for view, post, and/or comment on, upcoming shows, results of completed shows, winners circle, blogs, discussions, classifieds, etc.

In one or more arrangements, system 10 is configured to permit users to create new communities, assign moderators, set rules and/or criteria for use of the community, among other administrative configurations. In one or more arrangements, a creator, moderator, or other authorized user of a community may set qualifications for new users to join the community. As one example, a particular community may require membership in a particular club to joint. As another example, a particular community may require exhibitors participate in multiple exhibition events before they are permitted to join. Such prerequisites may help to prevent internet trolls from disrupting healthy discourse in the community. As an illustrative example, a community of rabbit exhibitors may require new members of the community to have entered at least one rabbit in two different events. In this manner, animal rights activist may be discouraged from joining and disrupting the community of rabbit exhibitors.

### In Operation

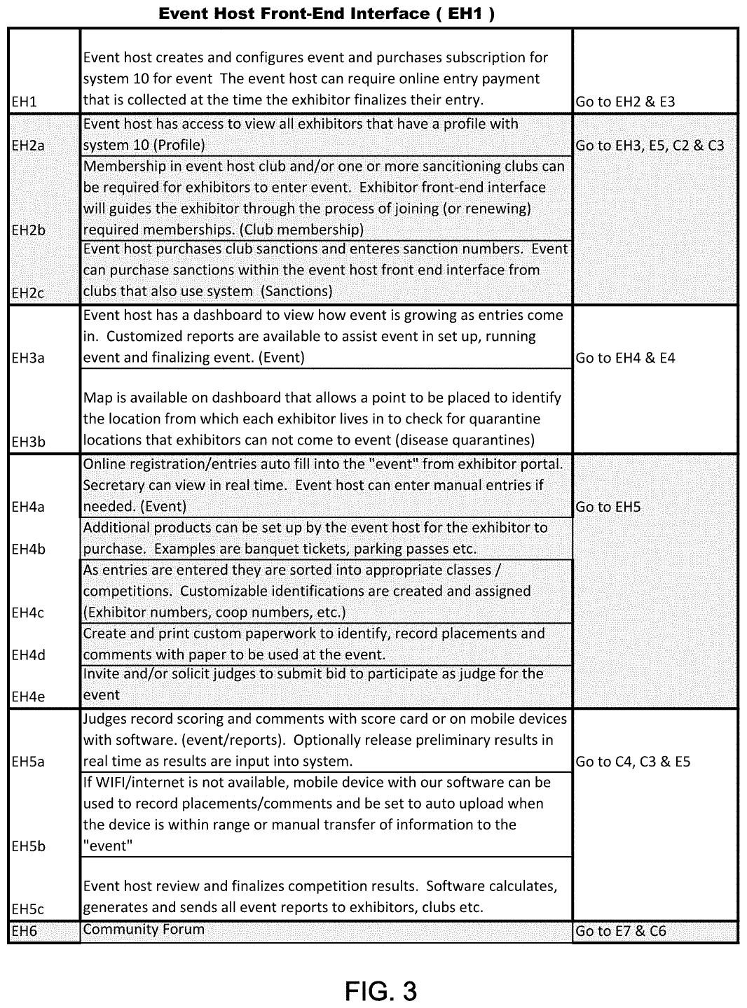

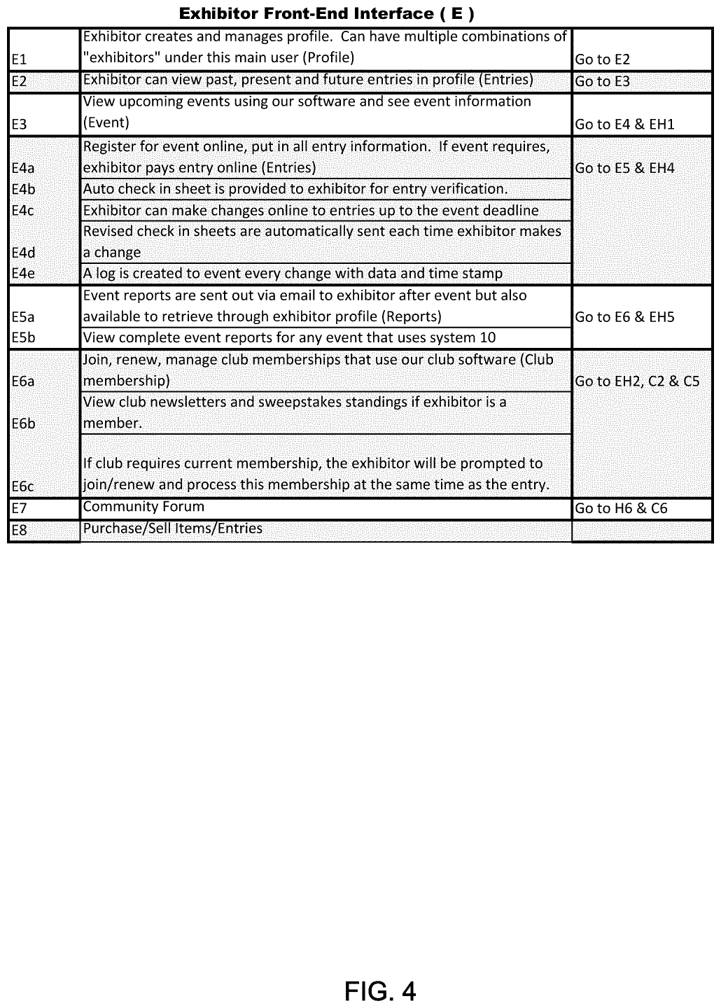

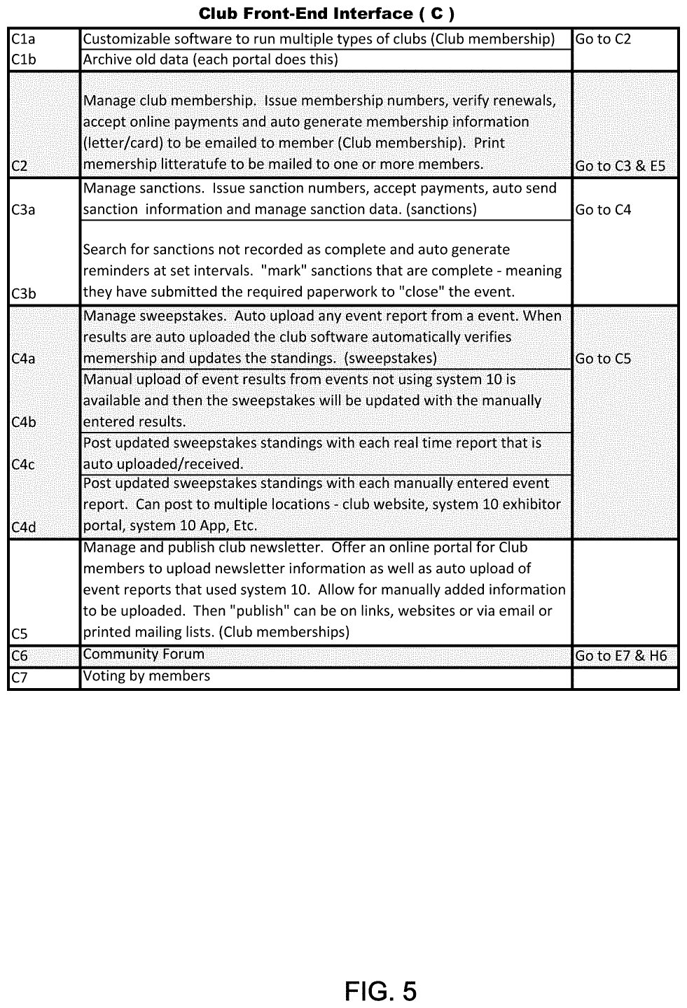

FIGS. 3-5 shows an example process flow in use of front-end systems 12 by users at various stages for an example event, in accordance with one or more arrangements.

### Exhibitor Front-End System 12b

(E1) The exhibitor front-end system 12b allows an exhibitor to create a profile with a username and password. In some arrangements, multiple users may be associated with and use an exhibitor profile. In one example arrangement, the first person is the “main” user and each main user can have up to 10 “sub-users.” A sub-user is another person or combination of people typically but not necessary living at the same address and using the same email address. However, the arrangements are not so limited. Rather, it is contemplated that, system 10 may be configured to permit any number of sub-users. In one or more arrangements, the system 10 identifies exhibitors, secretaries, clubs with emails address. Using exhibitor front-end system 12b, the exhibitor can maintain their profile, update their address, email, club memberships, etc.

(E2) In this example arrangement, the exhibitor front-end system 12b also allows the exhibitor to view all events, past, present and future that the exhibitor has entered including additional products the exhibitor might have purchased for the event using exhibitor front-end system 12b. Such products may include but are not limited to banquet tickets, parking passes, access passes, event merchandise, and/or any other items related to the event. In one or more arrangements, results from past shows are available to the exhibitor from the exhibitor front-end system 12b in case the exhibitor misses or accidently deletes the emailed results reports. In one or more arrangements, the exhibitor front-end system 12b can allow the exhibitor to view complete show reports for events the exhibitor entered as well as any event that uses the system 10. In one or more arrangements, the exhibitor front-end system 12b can allow the exhibitor to view updates to event information in real-time as changes are made (e.g., by the event host, by clubs sanctioning the event, or by exhibitors registering entries).

(E3) In one or more arrangements, the exhibitor front-end system 12b allows potential exhibitors an opportunity to view upcoming events, number of register exhibitors in the event or in individual classes/contests. The exhibitor front-end system 12b allows exhibitors to view the uploaded flyers and/or other information about the event to learn more about the event locations, type of event, judges, entry fees, and/or times/dates, etc.

(E4) In one or more arrangements, the exhibitor can then choose to register to enter one or more events within exhibitor front-end system 12b by clicking a “participate” button. In some various arrangements, the event may be set up for payment online or for payment at the event. Both types allow the exhibitor to enter their own entries which then automatically uploaded to database 20 and made available in the event host front-end system 12a. In one or more arrangements, payments made online through the exhibitor front-end system 12b is processed by a secured 3-party processor. Exhibitors receive a receipt after payment though the system 10 with their transaction number for future reference.

In one or more arrangements, as soon as the exhibitor finalizes their entry, system 10 automatically emails or otherwise provides a “check-in sheet” to the exhibitor. As previously described, this check-in sheet allows the exhibitor to review their entry and verify they entry was received. In one or more arrangements, the exhibitor front-end system 12b permits exhibitors to register entries up to the event's designated “deadline.” Up to the deadline, the exhibitor can go into the exhibitor front-end system 12b as many times as needed to change/update/delete or add to their entry. Each time, the system 10 automatically generates a revised check-in sheet and emails or otherwise provides it to the exhibitor.

In one or more arrangements, a log is kept within the system 10, date and time stamped showing each and every change in case this information is needed in the future. Each time an entry is made or a change is made in the exhibitor front-end system 12b, it automatically updates in the event host front-end system 12a.

In one or more arrangements, the exhibitor front-end system 12b directly interacts with the event host front-end system 12a when an exhibitor registers for an event. In this example arrangement, the system 10 uploads each entry into the correct class/contest, which is set up by the event host in the event host front-end system 12a.

(E5) In one or more arrangements, the event host front-end system 12a will upload event results for each exhibitor back in the exhibitor front-end system 12b to show the results for that exhibitor as well as for all events that use system 10. In one or more arrangements, this feature is an upgrade and requires the event host and/or exhibitor have to opt for upgrade. In one or more arrangements, exhibitors are able to view results in real-time as they are entered into system 10 by judges or the secretary for the event host.

(E6) In one or more arrangements, the exhibitor front-end system 12b directly interacts with the club front-end system 12c when an exhibitor registers an entry for an event by identifying that an exhibitor is a member of a club that is affiliated with an event or if the event requires membership in a particular club to exhibit at the event. In one or more arrangements, the system 10 can notify the exhibitor that they need to be a member and if that club uses system 10 the member can sign up for the event (renew if their membership is expired) and the updated membership information will be shown to the event and event host front-end system 12a and with the “club” in the club front-end system 12c.

(E7) In one or more arrangements, the exhibitor front-end system 12b permits exhibitors to access and/or post information relating to the event in one or more community forums maintained on the system for access to event hosts, clubs, members, exhibitors and/or other users who are members of the community. Information submitted to a community forum on one of the front-end system 12 are automatically uploaded to community forum on the other front-end systems 12.

(E8) In one or more arrangements, the exhibitor front-end system 12b permits exhibitors to facilitate purchase or sale of various items by exhibitors as described herein. In some various arrangements, exhibitors may use exhibitor front-end system 12b to pay for and record purchase of items from other exhibitors/attendees, event hosts, or clubs. As previously descried, for tangible items purchased, upon completing a sales transaction system 10 updates check-in/check-out sheets for buyer and seller in exhibitor front-end system 12b to show sale of the item, so the purchaser will be permitted to leave the event with their purchase.

Previously, no system has provided a way for the exhibitor to look for events, enter, pay and receive their results as well as complete event results before. The system 10 interacts with each portion of the event in a way that moves the data back and forth for all portions to view.

### Event Host Front-End System 12a:

The event host front-end system 12a allows the secretary for the event host to set up and configure information and options for an event. In this example arrangement, event host front-end system 12a allows the secretary for the event to also enter event information for the exhibitors as well as adding any club information that the event might be sanctioned with. In one or more arrangements, required results reports for clubs, as well as required points for sweepstakes, are formatted/configured by system 10 so that all required results reports are created for the secretary for the event host and provided to the clubs who have sanctioned the event. In one or more arrangements, event host front-end system 12a is configured to provide a different graphical user interface and configuration options for different types of events. The event type could be species specific (in the case of animal exhibitions) or event type specific. The different options made available for different types of events may be configured by the admin/owner of system 10.

(EH1) In one or more arrangements, the event host front-end system 12a is set up by the event host when they subscribe to or purchase the use of the system 10 for an event. In one or more arrangements, system 10 may provide three options for an event host to use system: Traditional, Hybrid and Integrated. However, the arrangements are not so limited. Rather, it is contemplated that one or more arrangements may have more or fewer options than those described herein. In this example arrangement, the secretary also sets up their profile with their name, address, email, club name, username and password.

If event host chooses the Integrated system, they will set up an account with a 3^{rd} party credit card processor used by system 10, in which event host links a bank account to the credit card processor's account. This allows for the system 10 to facilitate payments to/from event hosts, exhibitors, and clubs, for example, for entry fees, membership fees, purchases, subscription/upgrade fees, or any other fees related to events and/or use of system 10. In one or more arrangements, the event host front-end system 12a provides access to many reports that event funds collected, fees paid and total money sent to the clubs account for verification.

If event host selects the Hybrid option, the event host does not link bank accounts to our credit card processor, and system 10 does not facilitate payments for the event.

If event host selects the Traditional option, the event host must do all data entry before and after the event. In this example arrangement, their exhibitor's do not have access to the exhibitor front-end system 12b. System 10 will run the event reports with the entry data entered first and then the event results entered after that by the secretary for the event host. In this example arrangement, event reports are still automatically sent out to the club and to the exhibitor front-end system 12b.

(EH2) In one or more arrangements, the event host front-end system 12a permits secretary to view all exhibitors who have set up a profile in the system 10. In one or more arrangements, membership in event host club and/or one or more sanctioning clubs can be required in order to register for an event. In one or more arrangements, if an event requires membership in a specific club, the exhibitor front-end system 12b interacts with the club front-end system 12c via back-end system 14. For example, when an exhibitor enters an event by identifying that an exhibitor is a member of a club that is affiliated with an event or if the event requires membership in a particular club to exhibit at the event, the system 10 can notify the exhibitor that they need to be a member. In this example arrangement, if that club uses system 10, the member can sign up for the event (renew if their membership is expired) and the updated club membership information will be shown to the event and event host front-end system 12a and with the club in the club front-end system 12c.

In one or more arrangements, the event host front-end system 12a can interact with any clubs that use system 10, thereby allowing the secretary for the event host to apply and purchase sanctions from those club's from within the event host front-end system 12a. This decreases the time spent by the secretary for the event host to obtain multiple sanctions from multiple clubs and having to write checks or send money other ways. If the event host purchases sanction from a club via system 10, a received sanction number (or other confirmation) is automatically uploads into the event information in database 20 and event host front-end system along with any other requirements for the sanction (e.g., results reporting format and information).

(EH3 & EH5) In one or more arrangements, entries collected for Hybrid and Integrated options thru the exhibitor front-end system 12b are automatically uploaded into database 20. In this example arrangement, the event host does have the ability in both options to manually enter any entries from exhibitors without online access. In this example arrangement, event hosts using the Hybrid and Traditional options must manually collect entry fees at the event or using another arrangement.

(EH3) In one or more arrangements, the secretary for the event host can view how entries are coming in, see how many in each class have been entered, fees collected, a map showing where exhibitors are “from” is available on the secretary dashboard as well as statistics showing the number of online entries, manual entries, different divisions the entries are in an any other statistics the secretary for the event host requires.

(EH4a) In one or more arrangements, event host has access to all exhibitors that have a profile in the system 10. In one or more arrangements, if a previous event host has set up an exhibitor, the system 10 displays that to future event hosts that attempt to manually enter that exhibitor by either entering their first name, last name or email address. This prevents duplicate exhibitor profiles of the same person in our system.

(EH4b) In one or more arrangements, a record of additional products that the exhibitor has purchased is uploaded from the exhibitor front-end system 12b and maintained in backend system 14, where fees for such items are collected in the integrated system and the record may be accessed using event host front-end system 12a.

(EH4c) In one or more arrangements, as exhibitors register entries for the event via exhibitor front-end system 12a, entries uploaded from the exhibitor front-end system 12b backend system 14, where they are accessible via event host front-end system 12a. In this example arrangement, event-host front-end system 12a groups entries by class/competition.

(EH4d) In one or more arrangements, if the event host chooses not to use a mobile device at the event to record placements/comments, system 10 can print a variety of event specific material that the event would need to record the scoring/comments at the show.

(EH4e) In one or more arrangements, event host front-end system 12a provides an interface for the event host to invite and/or solicit judges to submit bid to participate as judge for the event as previously described.

(EH5) In one or more arrangements, on event day, system 10 can be used at the competition area/table/ring with via a personal electronic device to record the placements and/or placements and comments in real time. If the event host chooses not to use a mobile device at the event to record placements/comments, judges record the scoring/comments on paper score cards at the show and then the secretary for the event would input the scorings/comments into the system 10 and finalize the results for the event. In one or more arrangements, system 10 can generate coop numbers, exhibitor numbers or any other required identifier for entries or exhibitors to be used at the event in any type of format.

(EH5c) In one or more arrangements, once scoring/comments have been input, event host may prompt system 10 to automatically generate and send (e.g., email) required results reports for the event, for example by clicking a button in event host front-end system 12a. In this example arrangement, event host may print any reports that are required by an exhibitor without an email address or for clubs that require a hard copy to be mailed. However, the arrangements are not so limited. Rather, it is contemplated that an admin/owner may configure system 10 so to permit event hosts to setup, manage, execute, finalize results, and generate and send for events using any process or sequence of steps. Further, any type of report can be created to comply with all types of events/contests.

(EH5c) In one or more arrangements, logs are kept to record all statistical data for each event as well as logs showing what reports went out, to whom and when. The secretary for an event host can resend any reports easily from the event host front-end system 12a. In one or more arrangements, the event host front-end system 12a gets instant updates for data input or changes made by exhibitor front-end system 12b as an exhibitor registers for an event. In this example arrangement, the system 10 uploads each entry into the correct class/contest for the event, which is set up in the event host front-end system 12a.

(EH5c) In one or more arrangements, the event host front-end system 12a will upload competition results for each exhibitor to back-end system 14. The exhibitor front-end system 12b may then access results of the event for that exhibitor as well as for all events that use system 10. In one or more arrangements, this feature is an upgrade and requires the exhibitor or event host opt for the upgrade.

(EH5c) In one or more arrangements, the event host front-end system 12a will send results reports to any club automatically, for example, by automatically uploading the reports into the into the club front-end system 12c and/or communicating the reports to the club via the club's selected method delivery (e.g., email, ftp, dropbox, mailing, etc).

(EH6) In one or more arrangements, the event host front-end system 12a permits event host to access and/or post information relating to the event in one or more community forums maintained on the system for access to event hosts, clubs, members, exhibitors and/or other users who are members of the community. Information submitted to a community forum on one of the front-end systems 12 are automatically uploaded to community forum on the other front-end systems 12.

### Club Front-End System 12c:

(C1) The club front-end system 12c is set up by a club: local, state, regional, national or other, with the club's information and club secretary information. A username and password are assigned. In one or more arrangements, the club front-end system 12c has 3 primary components: membership, sanctions & sweepstakes.

(C2) Membership—In one or more arrangements, the membership portion of the club software allows members to join or renew their membership online. In one or more arrangements, a payments process 24c of backend system 14 is used to automate the membership process. In one or more arrangements, once payment is completed, the system 10 then issue (re-issues) the membership number, send a membership letter and card or other material that the club pre-determines is needed for new or renewing members. In one or more arrangements, system 10 permits a user to print membership literature so it can be mailed to one or more desired members (e.g., members without email addresses). In one or more arrangements, system 10 keeps track of membership information set up by the club including but not limited to, for example, name, address, email, years a member, type of membership, membership fees paid etc. In one or more arrangements, the club front-end system 12c may permit the secretary for the club to generate reports showing expired membership, soon to expire membership or any other reports the club needs. In one or more arrangements, the club front-end system 12c can send out a pre-drafted email alerting expiring members to the upcoming expiration but also alerting them to upcoming events, or any other information. In one or more arrangements, the club front-end system 12c can send an alert to the exhibitor in the exhibitor front-end system 12b of expiring memberships.

(C3) Sanctions—In one or more arrangements, if a club requires the events/contest to be sanctioned with a club, system 10 may be configured by the club front-end system 12c to process sanctions and payments online (e.g., using payments process 24c) and then auto-generate the sanction number and any literature needed to go to the secretary for the event host. The sanction number that is then recorded in the event host front-end system 12a and is automatically put on all reports generated for the club. In one or more arrangements, the club secretary can use the club front-end system 12c to generate reports showing missing or late sanction reports, pending sanctions etc.

(C4) Sweepstakes—Sweepstakes are points that exhibitors receive for placements at a sanctioned event. In one or more arrangements, if the secretary for the event host has sanctioned their event with a club using system, then the points that current members receive at the event can be automatically uploaded into the club records in the club front-end system 12c and members sweepstakes standings are automatically updated accordingly. In one or more arrangements, system 10 and/or club front-end system 12c is configured to verify membership status of exhibitors when updating club records and/or sweepstakes standing with data in new results reports. If exhibitors are current members, then the event results for the exhibitor are used to update club data/standings. Otherwise, the results of the exhibitor are stored in a separate location, where they can be retrieved manually if later if required for some reason. In one or more arrangements, the sweepstakes standing can be viewed on the club's media pages, newsletters or on the system 10 in real time, updating as quickly as events are finalized. In some various different arrangements, club front-end system 12c can be configured (e.g., by the admin/owners) for each category of club for their specific points structure. For example, the system 10 can show many different categories of club event reports (species/disciplines) as well as club reports and sweepstakes, membership, sanctions etc.

(C5) In one or more arrangements, the club front-end system 12c has a newsletter portion that allows designated members or club officers to upload articles, club news, event reports (auto or manual) and other information into a template for the club's newsletter and then that newsletter can be sent out to all members with a click of a button. In one or more arrangements, club front-end system 12c can send such information to the exhibitor front-end system 12b for all exhibitors that are current members for them to view from there. In one or more arrangements, sweepstakes, results reports, upcoming events and more can be uploaded automatically to the newsletter as well as all club social media, and/or provided to exhibitors via exhibitor front-end system 12b.

In one or more arrangements, membership and sanctions are processed online for the club by payments process 24c. In one or more arrangements, the club front-end system 12c may permit clubs to create various custom and standard reports that the clubs can use to monitor and keep track of all money, memberships, sanctions etc.

(C2) In one or more arrangements, the club front-end system 12c interacts with the exhibitor front-end system 12b via back-end system 14 to remind exhibitors when their memberships expire or are about to expire. In one or more arrangements, exhibitors can renew connected clubs through the exhibitor front-end system 12b to renew or join new suggested clubs and the club front-end system 12c then sends the member the designated member information.

(C3) In one or more arrangements, the club front-end system 12c interacts with the event host front-end system 12a via back-end system 14 to allow the secretary for an event host to order and pay for sanctions online and getting those sanctions immediately/automatically.

(C4) In one or more arrangements, as sweepstakes are updated in the club front-end system 12c from the results reports, system 10 is configured to post sweepstakes calculation updates can be post on various social media locations (e.g. webpages) and/or on exhibitor front-end system 12b for exhibitors that are members of the club.

(C5) In one or more arrangements, the club front-end system 12c can send the clubs newsletters to the exhibitor front-end system 12b for all current members as well as updated sweepstakes standings. In one or more arrangements, the club front-end system 12c, when exhibitors update their information in the exhibitor front-end system 12b, relevant information is automatically updated in club front-end system 12c.

Similarly, when the secretary for an event host updates their information in the event host front-end system 12a, relevant information is automatically updated in club front-end system 12c for the sanctioning clubs. In one or more arrangements, the club front-end system 12c can remind connected events/clubs that their membership is expiring and or if the sanctioning club requires a payment per entry in the event in addition to the sanction fee, the system 10 can calculate the additional payment required by the sanctioning club from the event/club and the event/club can pay that fee through the system 10. In one or more arrangements, the event host front-end system 12a will upload competition results for each exhibitor to the club software of the sanctioning club and if an exhibitor is a current member the points or results will be uploaded into the club's records.

(C6) In one or more arrangements, the club front-end system 12c permits clubs to access and/or post information relating to their club in one or more community forums maintained on the system for access to event hosts, clubs, members, exhibitors and/or other users who are members of the community. Information submitted to a community forum on one of the front-end system 12 are automatically uploaded to community forum on the other front-end systems 12.

(C7) In one or more arrangements, the club front-end system 12c permits clubs members to vote on various item related to various club activities/decisions. When an item is posted for election, system 10 may notify members with voting eligibility via club front-end system 12c email, text message, or any other method for communication. Members may review issues up for vote and select their desire option via club front-end system 12c. Upon close of the election period system 10 may tabulate results and communicate voting results to club members via club front-end system 12c email, text message, or any other method for communication.

In some various arrangements, club front-end system 12c, exhibitor front-end system 12b and event host front-end system 12a are implemented by one or more end-user devices that are communicatively connected (e.g., over the internet). For example, in one or more arrangements, the system 10 includes one or more web server(s) configured to provide web portals having graphical user interfaces configured for end users (e.g., exhibitors, secretary, club members) to input data to and use the club front-end system 12c, exhibitor front-end system 12b and event host front-end system 12a as described herein via a web browser on end user devices. In various arrangements, end-user devices may include but are not limited to, for example, computers, tablets, networked interfaces, smart phones, non-smart mobile phones, plain old telephones, wearable devices, and/or any other type of devices providing a user interface and communicative connection.

Although embodiments are described with reference to club front-end system 12c, exhibitor front-end system 12b and/or Event host front-end system 12a being provided by web application interfaces accessible via a web browser, the embodiments are not so limited. Rather, it is contemplated that in some various arrangements, club front-end system 12c, exhibitor front-end system 12b and/or event host front-end system 12a may additionally or alternatively include application program interface(s) provided by, for example, mobile applications, local executed programs, social media platforms, SMS, automated phone system, and/or any other type of communication platform.

Various blocks, modules, or other circuits may be implemented to carry out one or more of the operations and activities described herein and/or shown in the figures. In these contexts, a “block” (also sometimes “logic circuit,” “control circuit,” “processing circuit,” “server,” “module,” or “system”) is a circuit specifically configured and arranged to carry out one or more of these or related operations/activities. For example, such circuits may be discreet logic circuits or programmable logic circuits configured and arranged for implementing these operations/activities, as shown in the figures and/or described in the specification. In certain embodiments, such a programmable circuit may include one or more programmable integrated circuits (e.g., field programmable gate arrays and/or programmable ICs). Additionally or alternatively, such a programmable circuit may include one or more processing circuits (e.g., a computer, tablet, microcontroller, system-on-chip, smart phone, server, and/or cloud computing resources). For instance, computer processing circuits may be programmed to execute a set (or sets) of instructions (and/or configuration data). The instructions (and/or configuration data) can be in the form of firmware or software stored in and accessible from a memory (circuit). Certain aspects are directed to a computer program product (e.g., nonvolatile memory device), which includes a machine or computer-readable medium having stored thereon instructions which may be executed by a computer (or other electronic device) to perform these operations/activities.

In various implementations, disclosed blocks, modules, or other circuits, and/or devices may be communicatively connected using any number of communication protocols over various data networks and/or data buses, which may include but are not limited to, for example, Serial Data Interface 12 (SDI-12), UART, Serial Peripheral Interface, PCI/PCIe, Serial ATA, ARM Advanced Microcontroller Bus Architecture (AMBA), USB, Firewire, RFID, Near Field Communication (NFC), infrared and optical communication, 802.3/Ethernet, 802.11/WIFI, Wi-Max, Bluetooth, Bluetooth low energy, UltraWideband (UWB), 802.15.4/ZigBee, ZWave, GSM/EDGE, UMTS/HSPA+/HSDPA, CDMA, LTE, 4G, 5G, FM/VHF/UHF networks, and/or any other communication protocol, technology or network.

The various embodiments described herein are provided by way of illustration only and should not be construed to limit the invention. Based upon the above discussion and illustrations, those skilled in the art will readily recognize that various modifications and changes may be made without strictly following the exemplary embodiments and applications illustrated and described herein. For example, although implementations may in some cases be described in individual figures, it will be appreciated that features from one figure can be combined with features from another figure even though the combination is not explicitly shown or explicitly described as a combination. As another example, the structures and operations discussed herein may occur out of the order described and/or noted in the figures. For example, two operations and/or figures shown in succession may in fact be executed concurrently or may sometimes be executed in the reverse order, depending upon the functionality/acts involved. Similarly, individual operations within example methods described below may be executed repetitively, individually or sequentially, to provide looping or other series of operations aside from single operations described below. It should be presumed that any embodiment or method having features and functionality described below, in any workable combination, falls within the scope of example embodiments.

As used herein, various disclosed embodiments may be primarily described in the context of managing events that are sanctioned by third parties. However, the embodiments are not so limited. It is appreciated that the embodiments may be adapted for use with other types of events and/or used in other applications which may be improved by the disclosed structures, arrangements and/or methods. The system is merely shown and described as being used in the context of events that are sanctioned by third parties for ease of description and as one of countless examples.

From the above discussion and accompanying figures and claims it will be appreciated that the disclosed systems offer many advantages over the prior art. It will be appreciated further by those skilled in the art that other various modifications could be made to the device without parting from the spirit and scope of this invention. All such modifications and changes fall within the scope of the claims and are intended to be covered thereby. It should be understood that the examples and embodiments described herein are for illustrative purposes only and that various modifications or changes in the light thereof will be suggested to persons skilled in the art and are to be included in the spirit and purview of this application.

What is claimed is:

1. A system for management of events, comprising:
a back-end system;
the back-end system having a database;
the back-end system having a data processing system;
a first front-end system communicatively connected to the back-end system;
the first front-end system configured to provide a graphical user interface for an event host to create and configure an event and select a set of clubs the event host would like to sanction the event;
wherein in response to the set of clubs being selected via the graphical user interface provided by the first front-end system, the data processing system submits applications for purchase of sanctions from the set of clubs for the event;
wherein the data processing system is configured to track approval status of the applications for purchase of sanctions in the database;
wherein the data processing system is configured to store respective sets of club requirements for approved sanctions of the set of sanction sanctions in the database;
a second front-end system communicatively connected to the back-end system;
the second front-end system configured to provide a graphical user interface for exhibitors to register for the event;
wherein the data processing system is configured to maintain registration information for the exhibitors for the event in the database;
wherein upon determining finalized results of the event for the exhibitors, the data processing system is configured to generate a customized report of the finalized results of the event for each of the approved sanctions according to the respective set of club requirements for the approved sanction.

2. The system of claim 1, wherein the data processing system is configured to communicate the customized report to one of the set of clubs from whish the sanction was purchased.

3. The system of claim 1, wherein the respective set of club requirements for at least one of the approved sanctions requires payment of a fee per exhibitor to the club from which the approved sanction was purchased; and
wherein after closing of registration, the back-end system is configured to automatically calculate the total payment for the fee per exhibitor from data stored in the database;
wherein the back-end system is configured to automatically submit the calculated total payment to the club from which the approved sanction was purchased.

4. The system of claim 1, wherein the respective set of club requirements for at least one of the approved sanctions requires the event to include a club-specific award.

5. The system of claim 1, wherein the respective set of club requirements for at least one of the approved sanctions requires the event to include a club-specific award;
wherein the respective set of club requirements for the at least one of the approved sanctions specify a set of eligibility requirements for exhibitors to be allowed to compete for the club-specific award;
wherein the back-end system is configured to prevent exhibitors from registering to compete for the club-specific award unless the exhibitors satisfy the set of eligibility requirements.

6. The system of claim 1, further comprising a third front-end system communicatively connected to the back-end system;
the third front-end system configured to provide a graphical user interface for the set of clubs to register with the back-end system and process the applications for sanctions that are submitted by the data process system of the back-end system.

7. The system of claim 1, further comprising a third front-end system communicatively connected to the back-end system;
the third front-end system configured to provide a graphical user interface for the set of clubs to register with the back-end system;
the third front-end system configured to provide each of the set of clubs, from which approved sanctions were purchased, access the respective the custom report of the finalized results generated for the club by the data processing server.

8. The system of claim 1, further comprising a third front-end system communicatively connected to the back-end system;
the third front-end system configured to provide a graphical user interface for the set of clubs to register with the back-end system;
wherein for at least one club of the set of clubs, the data processing server is configured to track and maintain results and standings for members of the at least one club;
wherein the third front-end system configured to provide the members of the at least one club access to the results and standings for members of the at least one club.

9. The system of claim 1, wherein the second front-end system is configured to permit the exhibitors to initiate electronic payment for the registration using the back-end system.

10. The system of claim 1, wherein the user interface provided by the second front-end system is a web-based application executed on a personal electronic device.

11. The system of claim 1, wherein the user interface provided by the second front-end system is a local application downloaded onto a personal electronic device.

12. The system of claim 1, wherein on the back-end system is configured to receive scoring data for the exhibitors from a set of judges and store the scoring data the database;
wherein the back-end system is configured to determine the finalized results from the received scoring data.

13. The system of claim 1, wherein on the back-end system is configured to receive scoring data for the exhibitors from a set of judges and store the scoring data the database;
wherein the back-end system is configured to determine the finalized results from the received scoring data;
wherein the judges provide the scoring data to the back-end system using a web-based application executed on personal electronic devices.

14. The system of claim 1, wherein on the back-end system is configured to receive scoring data for the exhibitors from a set of judges and store the scoring data the database;
wherein the back-end system is configured to determine the finalized results from the received scoring data;
wherein web-based application is hosted by the first front-end system.

15. A system for creation and management of animal exhibition events, comprising:
a back-end system;
the back-end system having a database;
the back-end system having a data processing system;
a first front-end system communicatively connected to the back-end system;
the first front-end system configured to provide a graphical user interface for an event host to create and configure an event;
wherein the data processing system is configured to maintain configuration information for the event in the database;
a second front-end system communicatively connected to the back-end system;
the second front-end system configured to provide a graphical user interface for exhibitors to register for the event;
wherein the data processing system is configured to maintain registration information for the exhibitors for the event in the database;
wherein the data processing system is configured to generate a respective check-in/check-out sheet for each of the exhibitors indicating information for animals the exhibitor registered to bring to the event;
wherein the first front-end system is configured to permit a first one of the exhibitors to initiate a transaction for sale of at least one animal they registered to bring to the event to a second one of the exhibitors for a specified amount;
wherein in response to the transaction being initiated, the data processing system is configured to electronically transfer payment for the specified amount from the second one of the exhibitors to the first one of the exhibitors and update the respective check-in/check-out sheets for the first one of the exhibitors and the second one of the exhibitors to indicate the sale of the at least one animal.

16. The system of claim 15, wherein in initiation of the transaction, the first one of the exhibitors uses the second front-end system to input or select an identifier for the at least one animal and input or select an identifier for the second one of the exhibitors.

17. The system of claim 15, wherein the second front-end system is configured to provide each of the exhibitors access to the respective check-in/check-out sheet generated for the exhibitor.

18. The system of claim 15, wherein the user interface provided by the second front-end system is a web-based application executed on a personal electronic device.

19. The system of claim 15, wherein the user interface provided by the second front-end system is a local application downloaded onto a personal electronic device.
